(19) United States
(12) Patent Application Publication
(10) Pub. No.: US 2008/0021930 A1
(43) Pub. Date: Jan. 24, 2008

(54) SYSTEMS AND METHODS FOR TRACKING AND ASSESSING A SUPPLY MANAGEMENT SYSTEM

(75) Inventors: John E. Eisaman, Alexandria, VA (US); Joyce A. Kidd, Clinton, MD (US); Unchong Chung, Gaithersburg, MD (US); Craig Partridge, Stafford, VA (US); Raymond E. Miller, Falls Church, VA (US)

Correspondence Address: KNOBBE MARTENS OLSON & BEAR LLP, 2040 MAIN STREET, FOURTEENTH FLOOR, IRVINE, CA, 92614, US

(73) Assignee: United States Postal Service

(21) Appl. No.: 11/779,467

(22) Filed: Jul. 18, 2007

Related U.S. Application Data
(60) Provisional application No. 60/831,951, filed on Jul. 18, 2006.

(51) Int. Cl. G06F 7/00

(52) U.S. Cl. 707/104.1

(57) ABSTRACT

An apparatus and method for processing data associated with a supply chain management process assessment of an entity. In one embodiment the method includes receiving data in response to a request for supply chain management system assessment information from a plurality of users associated with the supply chain management system, the response data characterizing supply chain process elements in a plurality of categories for the at least one portfolio, transforming the response data in accordance with a predetermined transformation to a corresponding numerical value for each element, and generating a graphical display of at least a portion of the transformed response data, the graphical display comprising the numerical values for at least one elements in at least category for the at least one portfolio.

### RELATED APPLICATIONS

The application for patent claims priority to Provisional Application No. 60/831,951 entitled “SYSTEMS AND METHODS FOR TRACKING AND ASSESSING A SUPPLY MANAGEMENT SYSTEM” filed Jul. 18, 2006, which is assigned to the assignee hereof and hereby expressly incorporated by reference herein.

### BACKGROUND

1. Field

The invention relates generally to the evaluation of supply systems to determine operational goals and improve efficiency, and in particular to establishing, tracking and assessing measurable elements in multiple categories of a supply management system to establish and attain business objectives.

2. Background

Many medium to large business organizations require a supply chain system that provides numerous products that are needed on a day-to-day basis to support the organizations' operations. Such organizations typically have numerous business areas (for example, transportation, facilities, infrastructure, etc.) that are each supported by the supply chain system in accordance with specific demands that may or may not be applicable to the other business areas. Supply chain management is often done inconsistently from organization to organization, or even within different business areas of a single organization, due in part to the complexity of the management challenge. Managing a supply chain management typically involves monitoring a supply system to identify problem areas and correct supply problems as they occur. Such “real time” monitoring and correction can result in day-to-day problem solving without ever addressing the underlying causes of supply problems or the consideration of preemptive actions. Also, supply chain problems are difficult to address adequately simply due to the complexity of the supply system and its many variables.

There are few, if any, adequate assessment tools that identify the competencies and deficiencies in numerous areas of an organizations' supply system using a standardized system assessment. It would be useful to have a supply chain assessment model that tracks and assesses numerous aspects of a supply system and allows insight into which aspects of the supply system have the most impact in advancing the supply system towards supply chain management excellence in relation to best industry standards.

### SUMMARY OF CERTAIN EMBODIMENTS

The embodiments of various systems and methods described in this disclosure each have several features, no single one of which is solely responsible for its desirable attributes. Without limiting the scope of this disclosure, the more prominent features will now be discussed briefly. After considering this discussion, and particularly after reading the section entitled “Detailed Description of Certain Inventive Aspects” one will understand how the features described in this disclosure provide advantages over other supply management systems and methods.

One embodiment is a method of assessing one or more dimensions in a supply chain management system, the method including defining at least one category for each dimension, each category being associated with a portion of a supply chain management system; associating at least one element with each category, wherein each element is associated with one or more measurable criteria; determining a numerical value for each element based on the one or more measurable criteria associated with each element, assessing the one or more dimensions using the numerical value associated with each element; and determining a maturity level for the one or more dimensions based on the maturity level of the at least one category in each dimension.

The method can further include determining a maturity level for each category based on the numerical value of each associated element. Determining a maturity level for each category can include associating each category with one of four maturity levels based on the numerical value. In some embodiments, determining the numerical value includes performing one or more steps identified in “how-to” information that is associated with assessing each element. The how-to information can include one or more definitions, information for determining the measurable criteria associated with the element, and intervention tasks. The maturity levels can include planning, managing, executing, and excelling. In some embodiments, the plurality of categories include one or more of the following categories: strategy, supply chain integration, supply management leadership, human capital, cross-functional integration, innovation, client relationship management, supplier relationship management, performance measurement, value management, technology enablement, and results.

Other embodiments comprise a computer-implemented method for processing data associated with a supply chain management system assessment of at least one portfolio. The method includes receiving data in response to a request for supply chain management system assessment information from a plurality of users associated with the supply chain management system, the response data characterizing supply chain process elements in a plurality of categories for the at least one portfolio; transforming the response data in accordance with a predetermined transformation to a corresponding numerical value, and generating a display of at least a portion of the transformed response data, the display comprising the numerical values for at least one element in at least category for the at least one portfolio.

This method can further include receiving previous assessment results, and wherein the graphical display further comprises the previous numerical values for each element. Also, the method can include calculating the difference between the numerical value for each element and the previous numerical value for each element, and wherein the display further comprises displaying the difference for each element. The request for supply chain management process assessment information can include a questionnaire including at least one information request in at least a subset of the following information categories: strategy, supply chain integration, supply management leadership, human capital, cross-functional integration, innovation, client relationship management, supplier relationship management, performance measurement, value management, and technology enablement. In one aspect, the predetermined transformation comprises using measurable criteria and the response data to determine the numerical value for each element.

Another embodiment comprises an apparatus for processing data associated with a supply chain management system assessment of an entity comprises a processor-based system having a processor coupled to a memory and being operative to (i) receive data in response to a request for supply chain management system assessment information from a plurality of users associated with the supply chain management system, the response data characterizing supply chain process elements in a plurality of categories for the at least one portfolio; (ii) transform the response data in accordance with a predetermined transformation to a corresponding numerical value for each element; and (iii) generate a display of at least a portion of the transformed response data, the display comprising the numerical values for at least one element. The entity can include at least one of a company, an organization, and a project. The processor can be further operative to receive previous assessment results, and wherein the graphical display further comprises the previous numerical values for each element. Additionally, the processor is further operative to calculate the difference between the numerical value for each element and the previous numerical value for each element, and wherein the display further comprises displaying the difference for each element. In some aspects of this apparatus, the request for supply chain management process assessment information includes a questionnaire including at least one information request in at least a subset of the following information categories: strategy, supply chain integration, supply management leadership, human capital, cross-functional integration, innovation, client relationship management, supplier relationship management, performance measurement, value management, and technology enablement.

Another embodiment comprises a machine readable medium comprising instructions for processing data associated with a supply chain management system assessment, that upon execution cause a machine to receive data in response to a request for supply chain management system assessment information from a plurality of users associated with the supply chain management system, the response data characterizing supply chain process elements in a plurality of categories for the at least one portfolio; transform the response data in accordance with a predetermined transformation to a corresponding numerical value for each element; and generate a graphical display of at least a portion of the transformed response data, the graphical display comprising the numerical values for at least one element in at least category for the at least one portfolio.

In another embodiment, an apparatus for processing data associated with a supply chain management system assessment system includes means for receiving data in response to a request for supply chain management system assessment information from a plurality of users associated with the supply chain management system, the response data characterizing supply chain process elements in a plurality of categories for the at least one portfolio, means for transforming the response data in accordance with a predetermined transformation to a corresponding numerical value for each element, and means for generating a graphical display of at least a portion of the transformed response data, the graphical display comprising the numerical values for at least one element in at least category for the at least one portfolio.

### BRIEF DESCRIPTION OF THE DRAWINGS

FIG. 1 is a block diagram of a computer system that can implement incorporate the supply chain maturity assessment model.

FIG. 2 is a block diagram of a network system that can implement the supply chain maturity assessment model.

FIG. 3 is a diagram illustrating the various aspects of a supply chain system.

FIG. 4 is a flowchart illustrating a process for assessing a supply chain organization.

FIG. 5 is an assessment diagram illustrating the relationship between elements included in a Strategy category and maturity levels.

FIG. 6 is an assessment diagram illustrating the relationship between elements included in a Supply Chain Integration category and maturity levels.

FIG. 7 is an assessment diagram illustrating the relationship between elements included in a Supply Management Leadership category and maturity levels.

FIG. 8 is an assessment diagram illustrating the relationship between elements included in a Human Capital category and maturity levels.

FIG. 9 is an assessment diagram illustrating the relationship between elements included in an Innovation category and maturity levels.

FIG. 10 is an assessment diagram illustrating the relationship between elements included in a Cross-functional Integration category and maturity levels.

FIG. 11 is an assessment diagram illustrating the relationship between elements included in a value Management category and maturity levels.

FIG. 12 is an assessment diagram illustrating the relationship between elements included in a Supplier Relationship Management (SRM) category and maturity levels.

FIG. 13 is an assessment diagram illustrating the relationship between elements included in a Client Relationship Management (CRM) category and maturity levels.

FIG. 14 is an assessment diagram illustrating the relationship between elements included in a Performance Measurement category and maturity levels.

FIG. 15 is an assessment diagram illustrating the relationship between elements included in a Technology Enablement category and maturity levels.

FIG. 16 is an assessment diagram illustrating the relationship between elements included in a Results category and maturity levels.

FIG. 17 is a table illustrating the data measurements for the Strategy category elements.

FIG. 18 is a table illustrating data measurements for the Supply Chain Integration category elements.

FIGS. 19-24 are tables illustrating implementation instructions for elements of the Strategy category.

FIGS. 25-27 are tables illustrating implementation instructions for elements of the Supply Chain Integration category.

FIG. 28 is a table illustrating data measurements for elements in the Supply Management Leadership category.

FIG. 29 is a table illustrating data measurements for elements in the Human Capital and Innovation categories.

FIG. 30 is a table illustrating data measurements for elements in the Cross-functional Integration category.

FIG. 31 is a table illustrating data measurements for elements in the Value Management and Performance Management categories.

FIG. 32 is a table illustrating data measurements for elements in the Client Relationship Management and Supplier Relationship Management categories.

FIG. 33 is a table illustrating data measurements for elements in the Technology Enablement category.

FIG. 34 is a table illustrating data measurements for elements in the Results category.

FIGS. 35A-C are tables illustrating implementation instructions for the elements in the Supply Management Leadership category.

FIGS. 36A-D are tables illustrating implementation instructions for the elements in the Innovation category.

FIGS. 37A-F are tables illustrating implementation instructions for the elements in the Human Capital category.

FIGS. 38A-D are tables illustrating implementation instructions for the elements in the Cross-functional Integration category.

FIGS. 39A-C are tables illustrating implementation instructions for the elements in the Value Management category.

FIGS. 40A-D are tables illustrating implementation instructions for the elements in the Supplier Relationship Management category.

FIGS. 41A-E are tables illustrating implementation instructions for the elements in the Client Relationship Management category.

FIGS. 42A-C are tables illustrating implementation instructions for the elements in the Performance Management category.

FIGS. 43A-D are tables illustrating implementation instructions for the elements in the Technology Enablement category.

FIGS. 44A-H are tables illustrating implementation instructions for the elements in the Results category.

FIGS. 45A-H are tables illustrating examples of graphical layouts for displaying results of the maturity model assessment.

FIG. 46 is a flowchart illustrating a process of assessing one or more dimensions in a supply chain management system.

### DETAILED DESCRIPTION OF CERTAIN INVENTIVE ASPECTS

Although the following detailed description is directed to certain embodiments of the invention, the invention can be embodied in a multitude of different ways. The appearances of the phrase “in one embodiment,” “according to one embodiment,” or “in some embodiments,” or the like, in various places in the specification means that a particular feature, structure, or characteristic described in connection with the embodiment is included in at least one embodiment, but are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The following description includes details to provide a thorough understanding of the embodiments and examples. However, it is understood by one of ordinary skill in the art that the examples may be practiced even if every detail of a process or device in an example or embodiment is not described or illustrated herein. For example, computer-based systems may be shown in block diagrams that do not illustrate every electrical connection, every communication line, or every element of the system in order not to obscure the examples in unnecessary detail.

Those of ordinary skill in the art will further appreciate that the various illustrative components, systems, modules and algorithm steps described in connection with the examples disclosed herein may be implemented as electronic hardware, firmware, computer software, middleware, microcode, or combinations thereof. To illustrate this interchangeability of hardware and software, various illustrative components, blocks, modules, circuits, and steps have been described above generally in terms of their functionality. Whether such functionality is implemented as hardware or software can depend on the particular application and design constraints imposed on the overall system. Also, functionality (e.g., as embodied in software) described in some embodiments herein as being in a particular location or on particular computer can, in other embodiments, be in another location or on another computer in other embodiments. Skilled artisans may implement the described functionality in various ways for each particular application. Such implementation decisions should not be interpreted as causing a departure from the scope of the disclosed methods.

An objective of a management process for a supply chain system may be to achieve one or more business goals, for example, reducing costs, increasing customer satisfaction, and/or expanding supply chain excellence. However, due to the numerous variables that typically comprise a supply chain process for businesses, and in particular medium or large businesses, and because each business area may have its own supply chain process, an assessment of a supply chain process can be difficult, at best. As part of the process for meeting business goals, managing a supply chain process for an entity may involve monitoring numerous organizational “dimensions” and assessing each dimension using objective criteria in order to determine improvement.

To meet the above-stated goals, a process for assessing the various aspects of a complex supply chain management system is described herein and referred to as the “Maturity Model.” The Maturity Model defines one or more processes that can be embodied on a computer system for organizing and quantifying the many aspects that comprise a supply chain management system. The Maturity Model determines objective measurements from defined metrics. The measurements can be used to assess the “maturity” of the management system over a period of time (e.g., annually). Improvements in the supply system are identified as a “higher” level of maturity.

Embodiments of the Maturity Model described herein include examples of specific categories of assessment for a supply chain management system. In some embodiments, the Maturity Model may have more, fewer, or categories different than described in the embodiments described here. The Maturity Model has certain measurable elements, data measurements that are used to assess the maturity level of each element, and implementation instructions for each element. The Maturity Model can be quantifiable such that not only are elements of the model objectively measurable, but also there is a noticeable difference between assessed levels of maturity. The Maturity Model can also be actionable in that the model identifies areas in the supply chain process that management leadership can convert to goals. The Maturity Model can define the status of supply chain management excellence. The Maturity Model is also pervasive because it is comprehensive with respect to core end-to-end supply chain management activities and is a useful guide to achieving supply chain management excellence.

The Maturity Model can be used to assess the supply chain management of a business. It is ideally suited for medium and large businesses with complex supply chain interactions. However, it can also be used to assess any business supply chain. In such a business, typically there are numerous business areas (which are referred to herein as “portfolios”) each of which can have its own supply chain. In one example, an organization that conducts business that includes shipping items or goods can have portfolios that include Shipping Equipment, Transportation, Services, Facilities, Operations, Infrastructure, and Strategies. Assessment of each portfolio can be done using the same maturity model, as described herein below. Tracking assessment results from one assessment period to the next assessment period identifies if progress was made towards achieving supply chain management excellence, and it can identify areas needing improvement or additional resources.

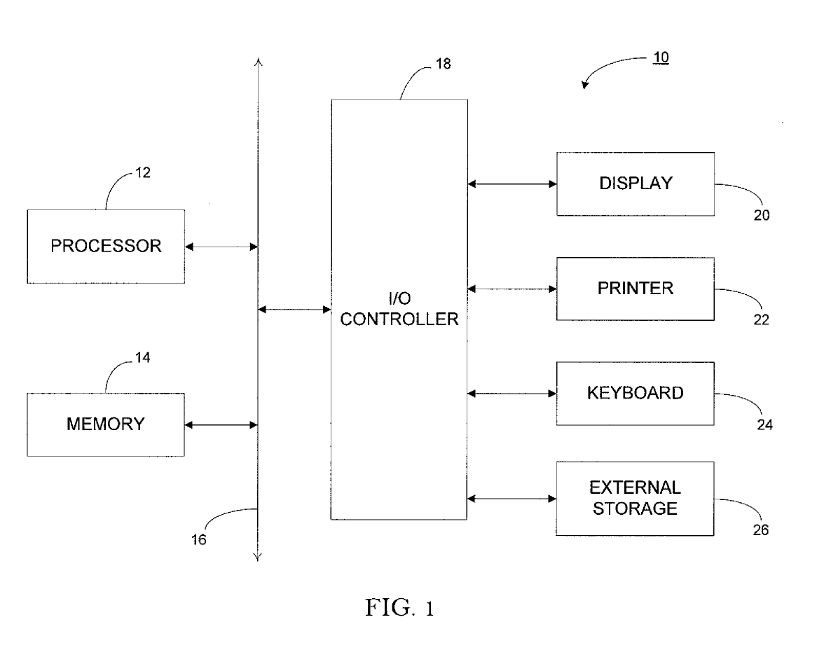

FIG. 1 shows an example of a processing system 10 in which the Maturity Model techniques may be implemented, in accordance with some embodiments of the invention. The processing system 10 includes a processor 12 and a memory 14 which are connected to a communication bus 16. The system 10 further includes an input/output (I/O) controller 18 which is connected to the bus 16 to communicate with the processor 12 and memory 14. Peripheral components are connected to the I/O controller 18. Examples of such peripheral components include a display 20, a printer 22, a keyboard 24 and an external storage device 26.

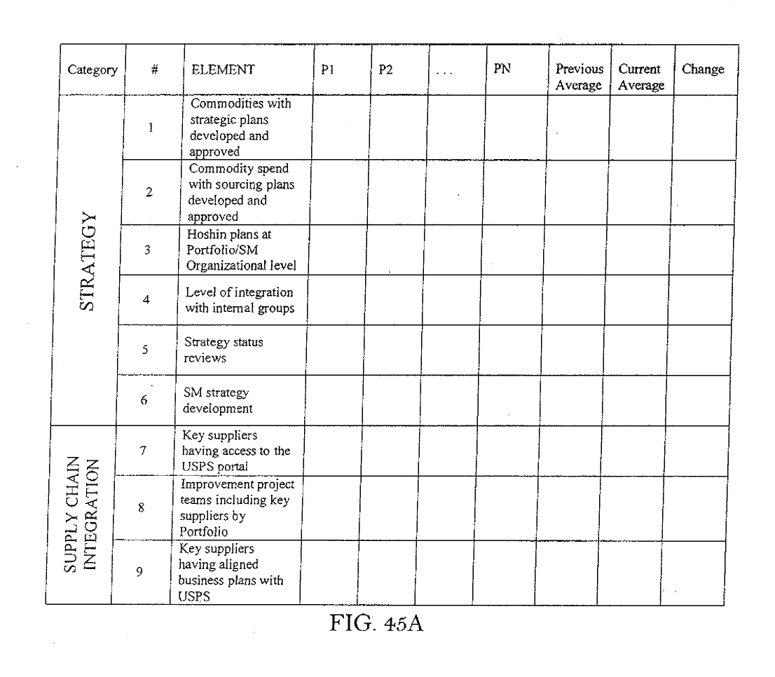

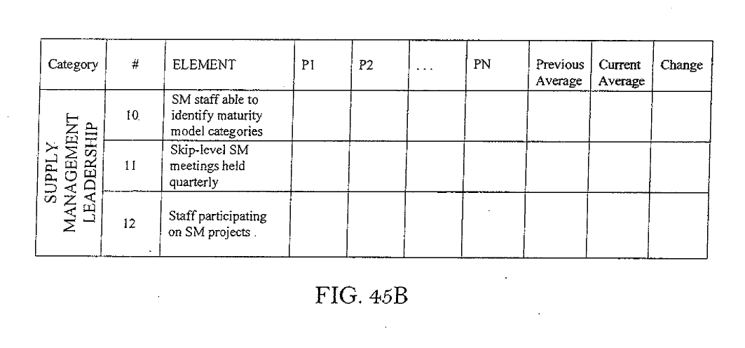

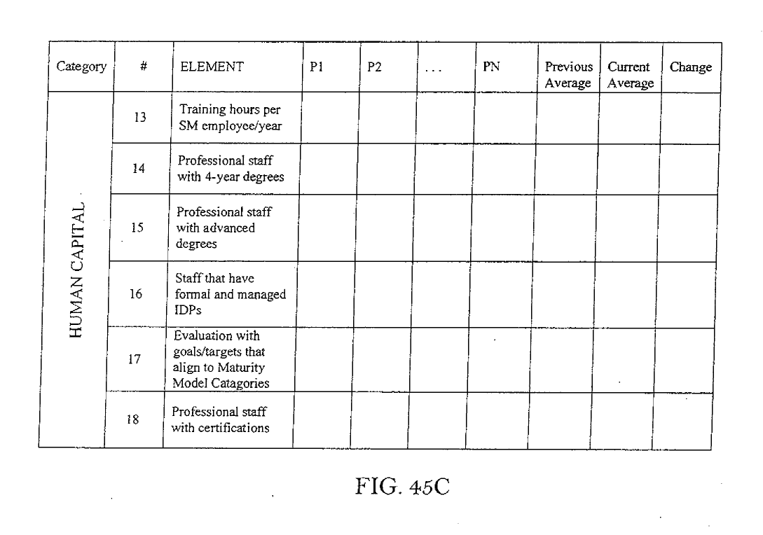

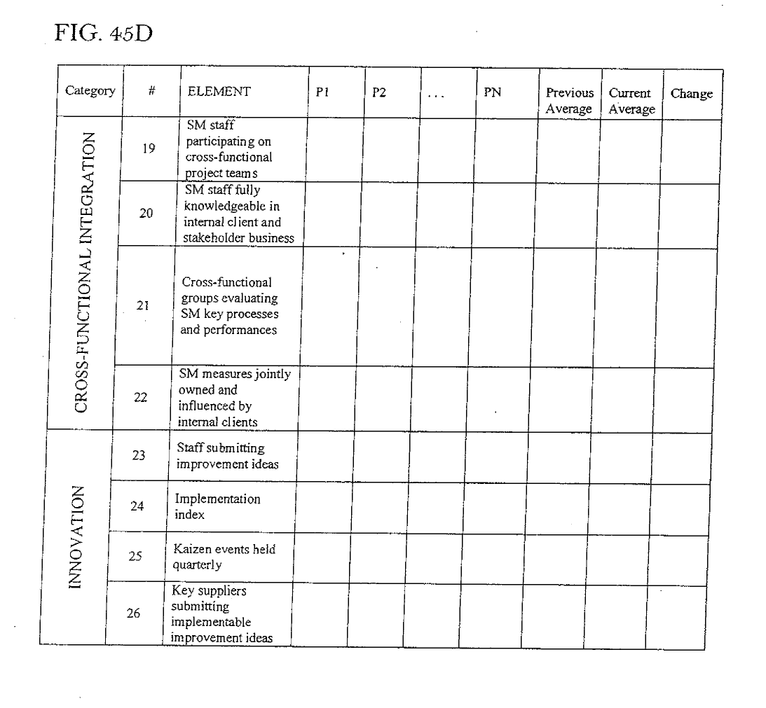

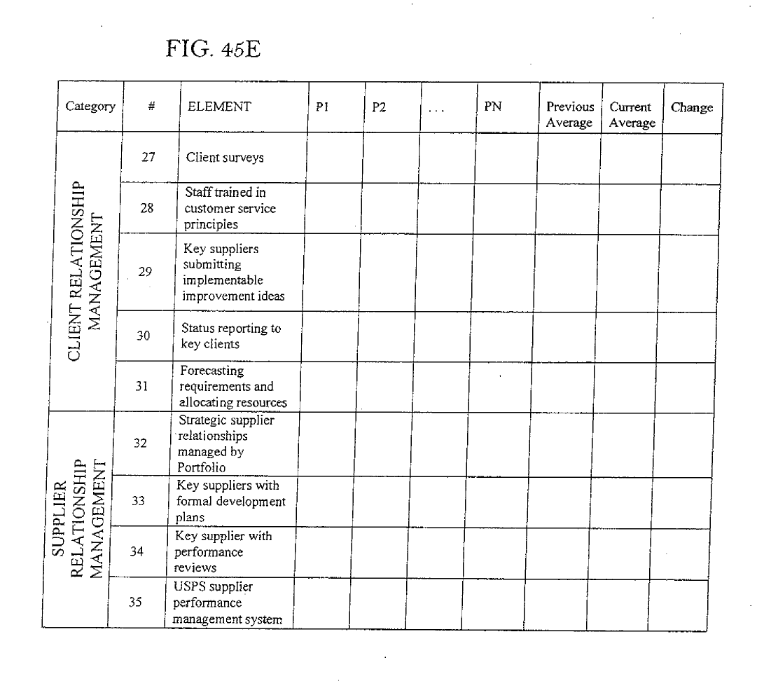

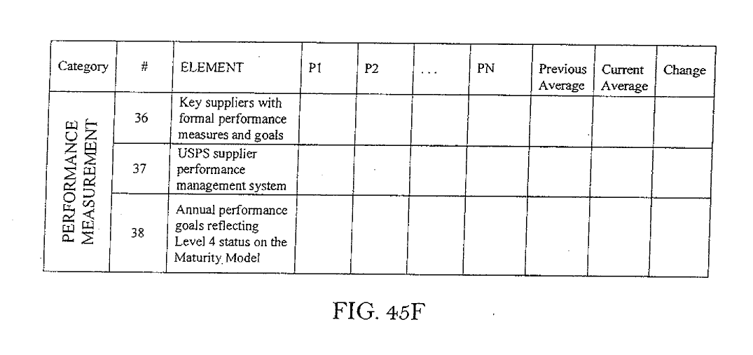

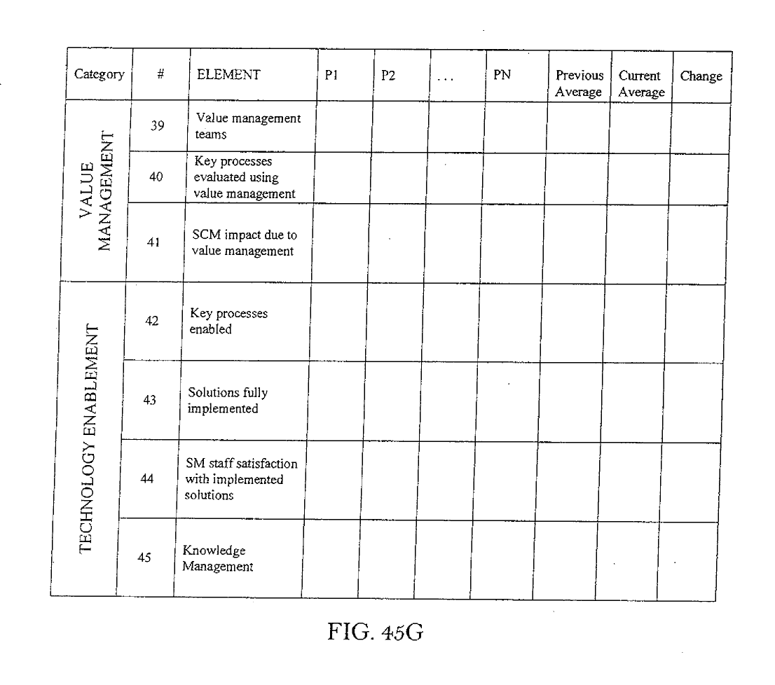

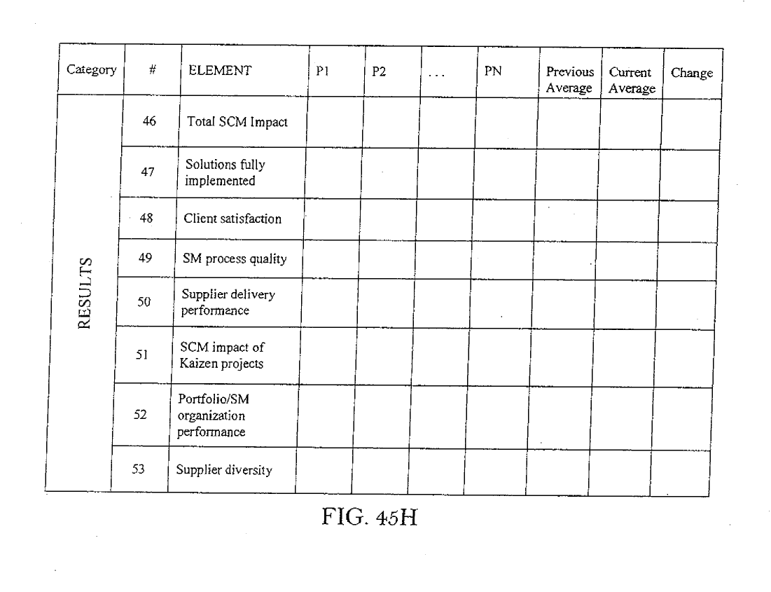

One or more of the elements of system 10 may represent portions of a desktop or portable personal computer, a workstation, a microcomputer, a mainframe computer, or other type of computer. The memory 14 and external storage device 26 may be electronic, magnetic or optical storage devices. The external storage device 26 may include a database comprising information on, for example, related companies, business organizations, or projects within an organization, etc. that is used to generate graphical charts, tables and other graphical displays that can be electronically displayed or printed. Some examples of graphical charts, tables and other graphical displays are illustrated in FIGS. 45A-H. The external storage device 26 may be a single device, or may be distributed, e.g., distributed across multiple computers or similar devices. The term “database” as used herein comprises any arrangement of stored data on a computing device including a relational database and a file.

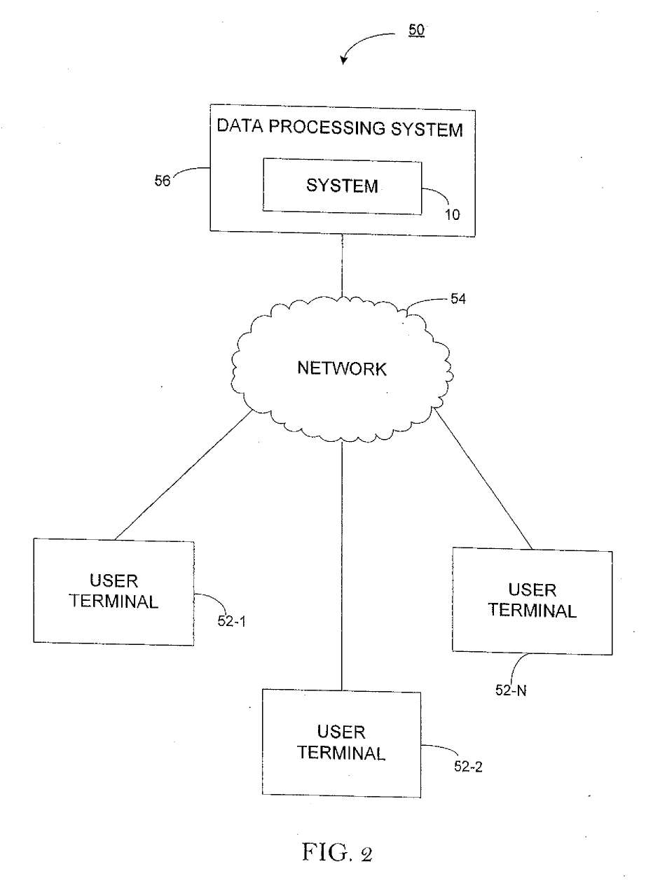

The Maturity Model may be implemented in the form of a computer software program stored in memory 14. The program is executed by processor 12 in accordance with user-supplied input data to produce a desired output in a predetermined format, e.g., on display 20 or on a print-out generated by printer 22. The user-supplied input data may be entered at the keyboard 24, read from one or more files of external storage device 26, or obtained over a network connection as will be described in conjunction with FIG. 2 below.

FIG. 2 illustrates an exemplary network-based system 50 in which the invention may be implemented. The system 50 includes a set of user terminals 52-i, where i=1, 2, . . . N coupled to a network 54. A centralized data processing system 56 is also coupled to the network 54, and includes the system 10 of FIG. 1 as well as additional supporting processing hardware and software. One or more of the user terminals 52-i may be, e.g., desktop or portable personal computers, workstations, personal digital assistants, or other types of digital data processors. For example, one or more of the user terminals 52-i may be a processing system configured as shown in FIG. 1. The network 54 may be, for example, the Internet, a local area network, a wide area network, an intranet, a telephone, cable or satellite network, as well as combinations or portions of these and other networks.

In operation, one or more of the user terminals 52-i accesses the centralized data processing system 56 via the network 54 to obtain Maturity Model-related information. For example, the centralized data processing system 56 may include a server which communicates with the user terminals 52-i via conventional Transmission Control Protocol (TCP)/Internet Protocol (IP) connections. As part of this communication, the system 56 may deliver a user questionnaire or other similar information request to one or more of the user terminals 52-i, e.g., as part of a web page configured in Hypertext Mark-Up Language (HTML) or other suitable file format and delivered over network 54 in accordance with, e.g., the Hypertext Transport Protocol (HTTP). The user questionnaire may contain, for example, a request for information related to assess a portfolio or an element, as described herein below. A particular user at one of the user terminals may initiate the communication process by, e.g., entering a Uniform Resource Locator (URL) or similar information identifying a web page associated with the system 56, in a web browser or other application program running on that user terminal. The user can then interact with the system 56 to supply chain related information which is processed in a manner to be described below. A report including one or more graphical displays of processed user information may then be delivered back to the user terminal over the network 54.

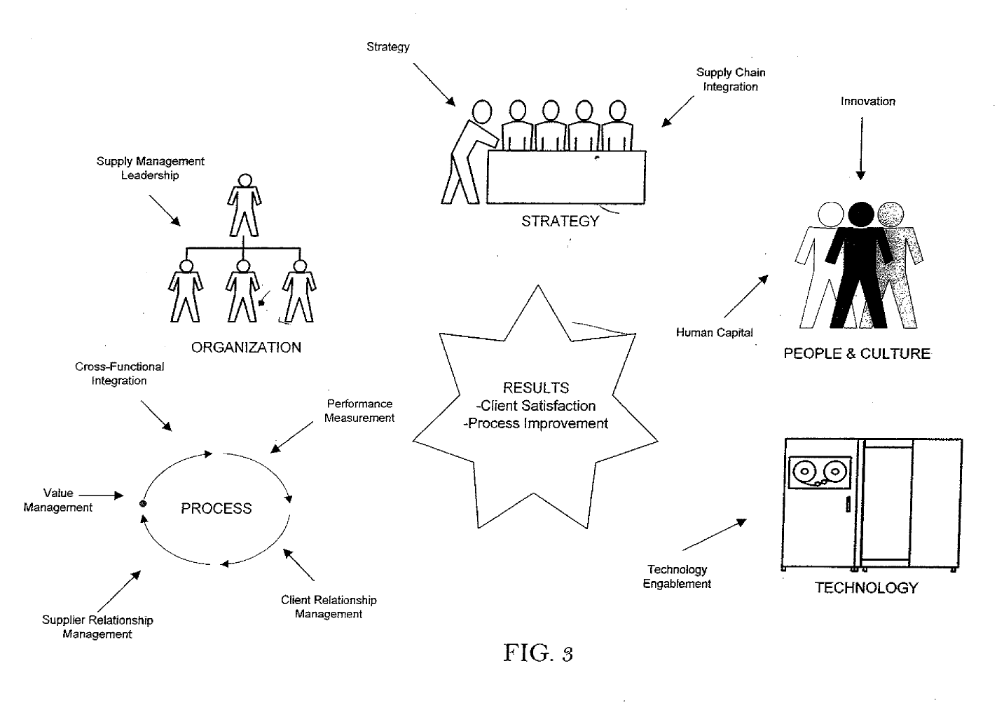

FIG. 3 is a diagram illustrating an overview of organizational aspects that can be associated with a supply chain management process for certain portfolios of a business, according to some embodiments of a Maturity Model. As illustrated in FIG. 3, the organizational aspects (which are also referred to herein as “dimensions”) include Technology, People and Culture, Strategy, Organization, and Processes. These organizational aspects, typically exist in businesses, but may be identified differently in various businesses.

FIG. 3 also illustrates examples of categories that can be included in each dimension of the supply chain organization, according to some embodiments. Each of the five dimensions shown includes one or more categories that identifies an important aspect of the dimension. For this example, the dimension Strategy includes the categories Strategy and Supply Chain Integration, the dimension Organization includes the category Supply Management Leadership, the dimension People & Culture includes the categories Human Capital and Innovation, the dimension Technology includes the category Technology Enablement, and the dimension Processes includes the categories Cross-Functional Integration, Value Management, Supplier Relationship Management, Client Relationship Management, and Performance Measurement. The Maturity Model also includes a “Results” category that indicates organization-wide performance, process improvement and client satisfaction. The Results category indicates results of the supply chain organization gained through improved supply chain management performance. While the categories are defined for the maturity model described herein, other embodiments of a Maturity Model can include other categories, depending on the particular implementation. The previously stated categories can be described as follows:

Strategy: a general direction set by supply management and its various components and activities to achieve a desired state in the future.

Supply Chain Integration: the linkage of a buyer and seller organization through technology, information, data, and shared knowledge so that the conduct of supply chain activities is faster, less expensive, and at a higher quality level.

Supply Management (SM) Leadership: the setting of organization strategic direction by supply management senior leaders followed by a client organization, clear communication, visible values, and high expectations. The values, directions, and expectations address all stakeholders. The leaders ensure the creation of strategies, systems, and methods for achieving excellence and building knowledge and capabilities. Leadership includes the ability of a manager to train employees, remove institutional roadblocks that hinder the natural tendency of people to produce quality, and empower employees to achieve quality goals.

Human Capital: the knowledge, skills, abilities, and capacities possessed by people.

Innovation: the implementation of a new idea that generates value in supply management.

Cross-Functional Integration: the process through which a group with diverse capabilities and responsibilities works together to solve common problems or accomplish a mutual goal by sharing information, knowledge, and experience.

Client Relationship Management (“CRM”): indicates the way supply management manages interactions with its clients. A successful CRM solution depends on the ability to interact with clients through any channel they choose, as well as a way to track and maintain real-time records of client interactions so a complete view of the client's previous interactions can be established. Effective CRM delivers the personalize, informed service on-demand that clients expect based on voice of customer (“VOC”) input.

Supplier Relationship Management (“SRM”): the management of the flow of information between suppliers and supply management, broken into the four categories of design, source, order, and monitor. SRM also includes the process of improving supplier performance and developing suppliers.

Performance Measurement: The process of developing measurable indicators and scorecards that can be systematically tracked to assess progress in achieving these goals by identifying gaps in performance. A performance gap is the gap between what clients and stakeholders expect and what each process and related sub-processes produce in terms of quality, quantity, time, and cost of services and products.

Value Management: a system that strategically aligns portfolios with the business entity goals by focusing on value drivers, supply management program, initiatives, and plans that tend to improve operating cash flow and client satisfaction. Value management evaluates processes, systems, products and services to improve value-added, reduce costs, and/or improve quality and delivery performance.

Technology Enablement: a set of technology solutions that enable learning, collaboration, and real-time decision support and knowledge sharing to enhance supply management's productivity.

Results: Organization-wide performance based on the maturity levels attained in the other eleven categories of the model.

Each category of the Maturity Model includes at least one element. An element is a quantifiable measure that is used to indicate progress towards supply chain excellence within the category. In the categories described above, each of the categories in the Maturity Model includes two or more elements. In some embodiments, the elements are equally weighted. Alternatively, the elements can be unequally weighted such that a particular element will have a greater or lesser effect on the assessment of the category. For example, management may weight one or more of the elements to emphasize an element's importance to the assessment. Supply chain management excellence can be defined in terms of industry best practices, and specifically defined in relation to the elements. Assessment of the elements associated within a category, and for each category of a dimension, are used to assess the overall maturity level of the dimension. The maturity level for each element can be benchmarked against such industry practices. The elements of the exemplary described herein Maturity Model are listed below in reference to their associated dimension and category:

Dimension: Strategy

Category: Strategy

| | |
|---|---|
| Elements | Commodities with strategic plans developed and |
| | approved |
| | Commodity spend with sourcing plans developed and |
| | approved |
| | Hoshin plans at Portfolio/SM Organizational level |
| | Level of integration with internal groups |
| | Strategy status reviews |
| | SM strategy development |

Category: Supply Chain Integration

| | |
|---|---|
| Elements | Key suppliers having access to the USPS portal |
| | Improvement project teams including key suppliers |
| | by Portfolio |
| | Key suppliers having aligned business plans with |
| | USPS |

Dimension: Organization

Category: Supply Management Leadership

| | |
|---|---|
| Elements | SM staff able to identify maturity model |
| | categories |
| | Skip-level SM meetings held quarterly |
| | Staff participating on SM projects |

Dimension: People and Culture

Category: Innovation

| | |
|---|---|
| Elements | Staff submitting improvement ideas |
| | Implementation index |
| | Kaizen events held quarterly |
| | Key suppliers submitting implementable |
| | improvement ideas |

Category: Human Capital

| | |
|---|---|
| Elements | Training hours per SM employee/year |
| | Professional staff with 4-year degrees |
| | Professional staff with advanced degrees |
| | Staff that have formal and managed integrated |
| | data plans |
| | Evaluation with goals/targets that align to |
| | Maturity Model |
| | Professional staff with certifications |

Dimension: Processes

Category: Cross-functional Integration

| | |
|---|---|
| Elements | SM staff participating on cross-functional project |
| | teams |
| | SM staff fully knowledgeable in internal client |
| | and stakeholder business |
| | Cross-functional groups evaluating SM key |
| | processes and performances |
| | SM measures jointly owned and influenced by |
| | internal clients |

Category: Value Management

| | |
|---|---|
| Elements | Value management teams |
| | Key processes evaluated using value management |
| | SCM impact due to value management |

Category: Supplier Relationship Management

| | |
|---|---|
| Elements | Strategic supplier relationships managed by |
| | Portfolio |
| | Key suppliers with formal development plans |
| | Key supplier with performance reviews |
| | USPS supplier performance management system |

Category: Client Relationship Management

| | |
|---|---|
| Elements | Client surveys |
| | Staff trained in customer service principles |
| | Key suppliers submitting implementable improvement |
| | ideas |
| | Status reporting to key clients |
| | Forecasting requirements and allocating resources |

Category: Performance Management

| | |
|---|---|
| Elements | Key suppliers with formal performance measures |
| | and goals |
| | USPS supplier performance management system |
| | Annual performance goals reflecting level 4 status |
| | on the Maturity Model |

Dimension: Technology

Category: Technology Enablement

| | |
|---|---|
| Elements | Key processes enabled |
| | Solutions fully implemented |
| | SM staff satisfaction with implemented solutions |
| | Knowledge Management |

Results

Category: Results

| | |
|---|---|
| Elements | Total SCM Impact |
| | Solutions fully implemented |
| Client satisfaction | SM process quality |
| | Supplier delivery performance |
| | SCM impact of Kaizen projects |
| | Supplier diversity |

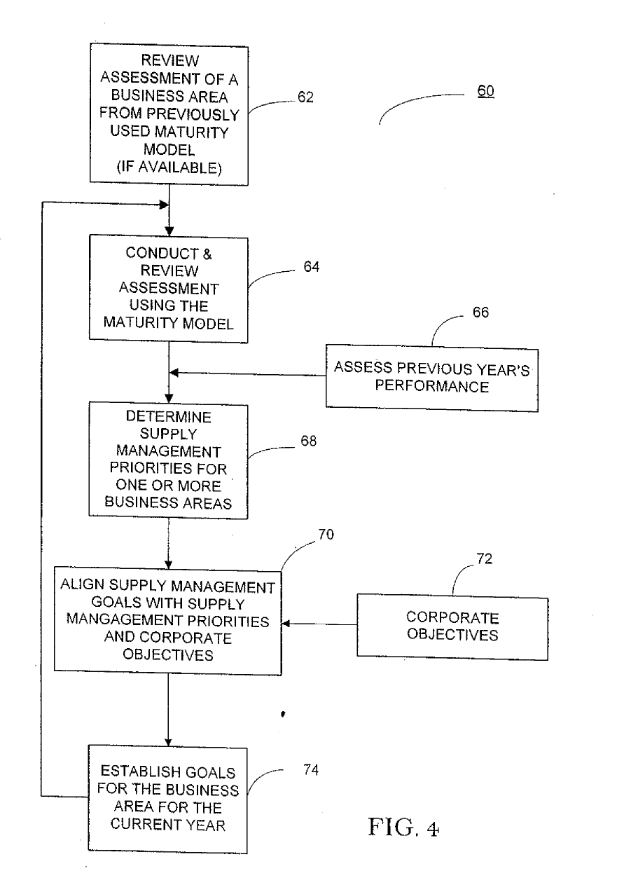

FIG. 4 is a flowchart illustrating a process 60 for assessing a business area of a supply chain organization. The process 60 starts at step 62 by reviewing the previous assessment of the business-area that may have been performed using the Maturity Model described herein, or another assessment model. The process 60 then proceeds to step 64 where the portfolio is assessed and reviewed using a Maturity Model. At step 66, if the same Maturity Model was used in a previous time period as the current time period, the results for the current period and the previous period can be compared and assessed to determine if any change to the assessment has occurred, and if so where it has occurred and the amount of change. At step 68, supply management priorities are determined for one or more portfolios. The priorities are typically determined by senior supply management based on a number of business factors, such as budget, organization goals, etc. At step 70, the process 60 receives corporate objectives 72 that are defined by the corporation's management (e.g., president, vice-president(s), or Board of Directors), and aligns supply management goals with supply management priorities and corporate objectives. Finally, at step 74 new goals for the business area are established for the current period, and the process 20 loops back to step 64 to conduct another assessment of the business area at the appropriate time.

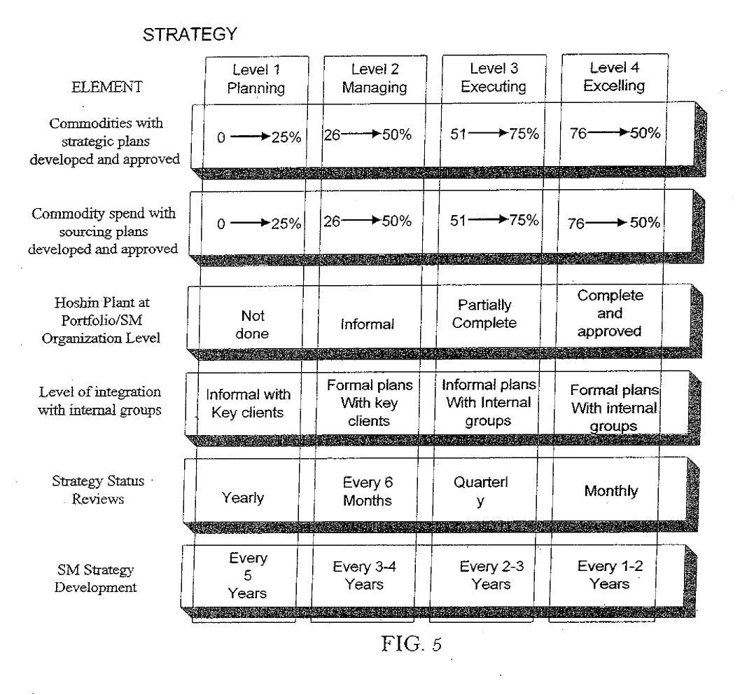

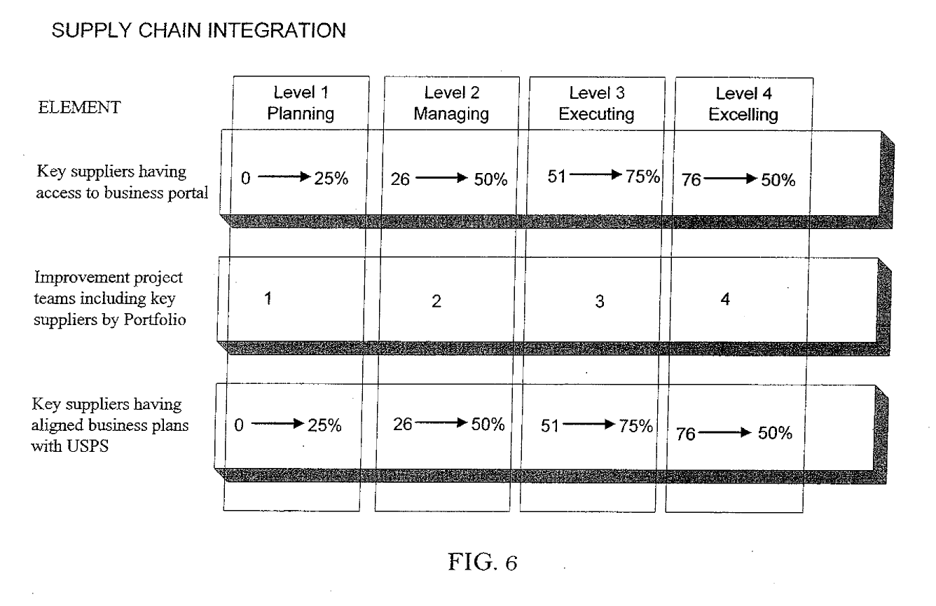

FIGS. 5 and 6 show the categories included in the Strategy dimension, namely the Strategy category (FIG. 5) and the Supply Chain Integration category (FIG. 6). FIGS. 5 and 6 also illustrate the elements included in each category, and the relationship between each element and a maturity level, according to some embodiments. Using the Maturity Model, the elements are assessed to be at one of four maturity levels. In some embodiments, a different number of maturity levels (e.g., fewer than four or more than four) can be determined and defined appropriately. Embodiments having more than four maturity levels can provide increased granularity of the assessment of the maturity of the process. When the assessment is completed, the results can be used to analyze the element in relation to previous results for the same portfolio, or to a different portfolio.

As shown in FIG. 5, the Strategy category, includes six elements, (1) commodities with strategic plans developed and approved; (2) commodity spend with sourcing plans developed and approved; (3) Hoshin plans at portfolio/supply management (“SM”) Organizational level; (4) level of integration with internal groups; (5) strategy status reviews; and (6) supply management strategy development. The Supply Chain Integration category as shown in FIG. 6, includes three elements: (1) key suppliers having access to the entity portal; (2) improvement project teams including key suppliers by portfolio; and (3) key suppliers having aligned business plans with the business entity. Each element of the Strategy dimension has one or more data measurements that are used to assess the elements and determine a “maturity level” that is associated with each element. The maturity level indicates the progress of the element towards achieving supply chain excellence. As a result of assessing the maturity level of an element, a numerical value or other quantifiable criteria is determined for the element to quantify the maturity level of each element. The maturity level value of the elements that are included in each category can then be used (e.g., averaged) to determine a maturity level value of the category.

For a particular dimension, the assessment of the supply chain management system's current maturity level by determining the maturity level of each category that comprises the dimension. The maturity level of a category can be determined by assessing the maturity level of each element in the category in accordance with predetermined measurable criteria (e.g., data measurements), examples of which are described in further detail below. According to some embodiments, the elements are assessed to be at one of four supply chain management maturity levels: Planning, Managing, Executing, or Excelling. The dimensions are assessed to be at a particular maturity level based on the maturity level assessment of its categories and elements in a roll-up fashion, that is, the maturity level of a category is derived from the assessed maturity level of its elements, and the maturity level of a dimension is derived from the assessed maturity level of its categories.

The maturity levels can have different meanings at the element, category, dimension, and/or portfolio levels. While the maturity level of an element is based on specific predetermined data measurements, the maturity level of a dimension or a portfolio provides a higher level view of the supply chain management system and indicates the overall excellence of supply-chain management in that dimension or portfolio.

In some embodiments, for example for a portfolio or a dimension, the assessed maturity level is at the lowest “Planning” maturity level when informal plans have been started, with some successes, metrics are not established or not tracked, reactive strategies have been developed due to lack of market or client analysis, and the supply management organization is beginning an initiative on the element(s). A category or a dimension is assessed to be at the “Managing” maturity level when formal plans have been developed and are being deployed, initial results have been achieved but not across the supply management organization, the customer's input has begun to be integrated into supply management organization processes, the focus of the supply chain process is on price only, and few highly productive approaches have been implemented. A category or a dimension is assessed to be at the “Executing” maturity level when moderate results are being achieved by groups across the supply management organization, the supply chain is an integrated process and the supply management organization is achieving high client satisfaction, and metrics are being tracked and the SM organization is continuously improving results. A category or a dimension is assessed to be at the “Excelling” maturity level when significant results are being achieved based on continuous improvement efforts; the supply chain is fully integrated with suppliers and clients; the supply management organization is considered internal benchmark and can be favorable compared to external benchmarks.

The maturity level assessment begins with assessing the maturity level of the elements. Example of maturity levels of the elements in the Strategy category and elements in the Supply Chain Integration category are illustrated in FIGS. 5 and 6, respectively. Specifically, FIG. 5 illustrates the relationship between the elements of the Strategy category and four maturity levels. Referring to FIG. 5, the maturity level of each element in the Strategy category can be determined to be one of four maturity levels described above. For example, the element “Commodities with strategic plans developed and approved” is assessed to be at maturity level 1 “Planning” if the percentage of completion is of the element is 0-25%, level 2 “Managing” if 26-50%, level 3 “Executing” if 51-75%, and level 4 “Excelling” if 76-100%.

Although numerous elements in the Maturity Model are assessed by the percentage of completion, other elements can be assessed based on other factors. For example, the third element “Hoshin plans at portfolio/supply management (SM) organization level” is assessed to be at a maturity of level 1 if it is not done, level 2 if it is informally completed, level 3 if is partially completed, and level 4 if it is completed and approved. Note: In Hoshin planning is a management strategy that focuses and aligns an organization to achieve breakthroughs for customers, and is known by persons of skill in the art. In another example, the fourth element in the Strategy category “level of Integration with internal groups” is assessed to be at level 1 “Planning” if there are informal supply management strategic plans with key clients, at level 2 “Managing” if the plans are formal with key clients, at level 3 “Executing” if there are informal plans integrated with internal groups, and assessed to be at level 4 “Excelling” if there are formal plans integrated with internal groups.

In yet another example, the element “Strategy status reviews” is assessed to be at a particular maturity level based on its frequency, e.g., level 1 if yearly, level 2 if completed every six months, level 3 if completed quarterly, and level 4 if completed monthly. The last element of the Strategy category “SM strategy development” is also assessed based on its frequency, e.g., at level 1 if completed every 5 years, at level 2 if completed every 3-4 years, at level 3 if completed every 2-3 years, and at level 4 if completed every 1-2 years. Other such criteria can be also be used as appropriate to transform data received or collected in response to addressing predetermined criteria to a maturity level and a quantifiable value.

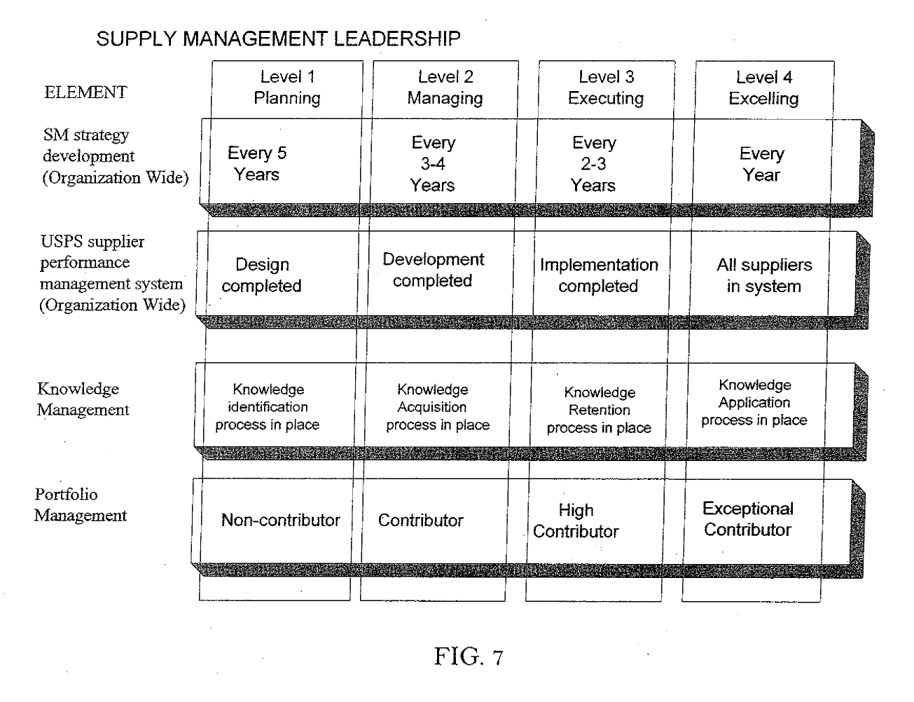

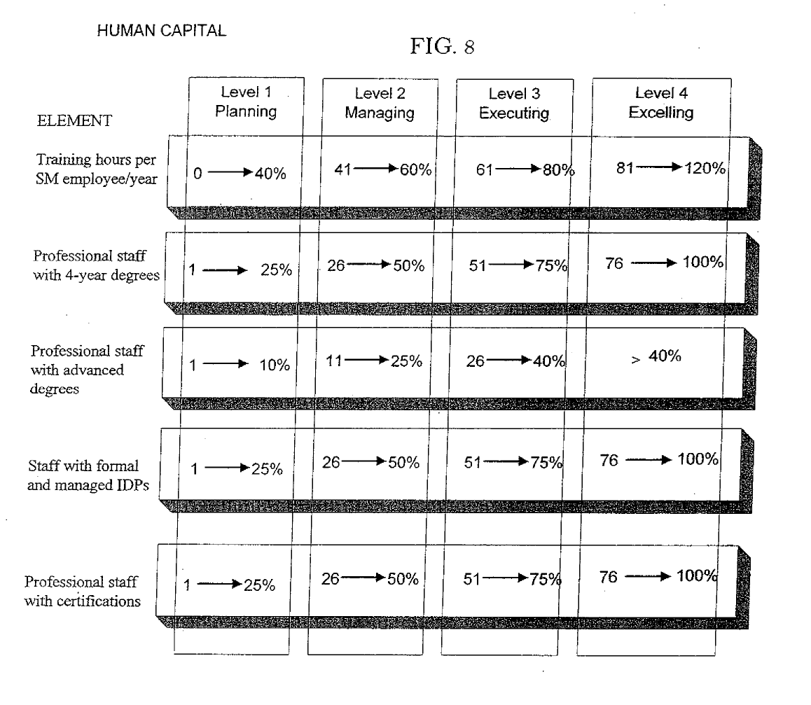

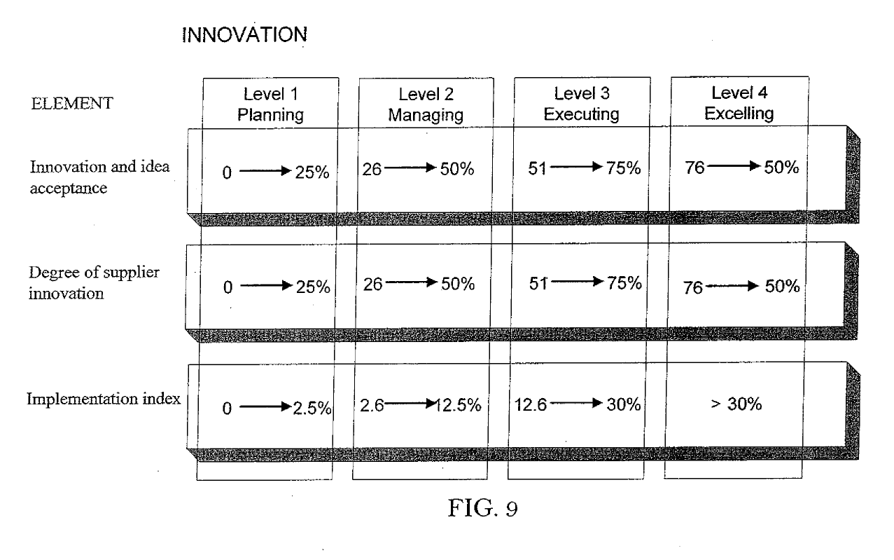

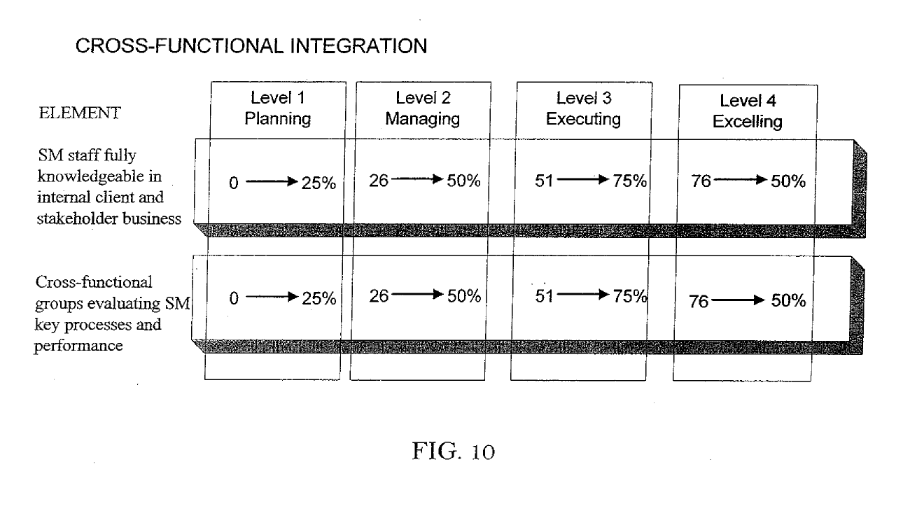

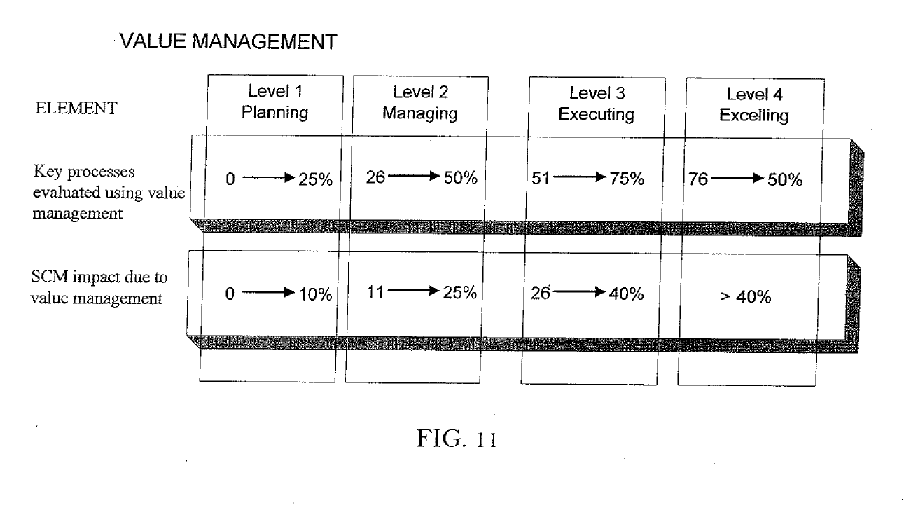

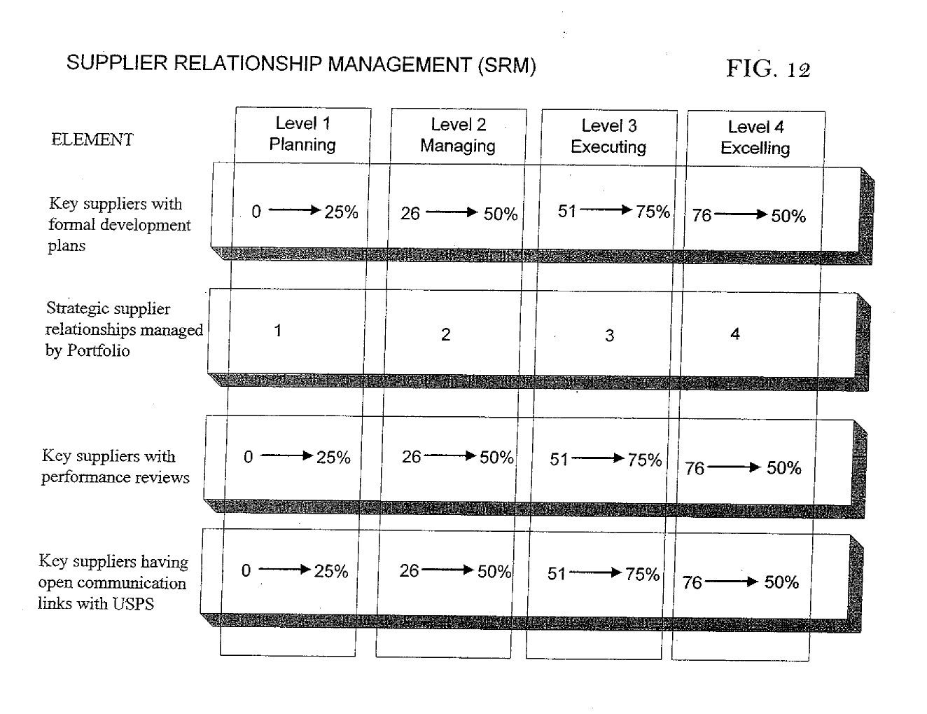

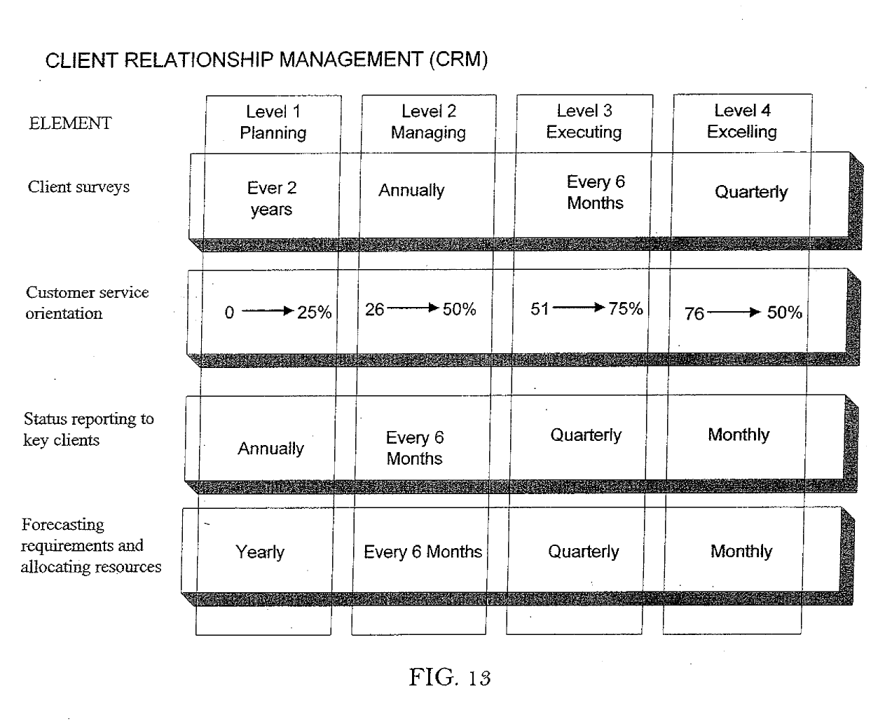

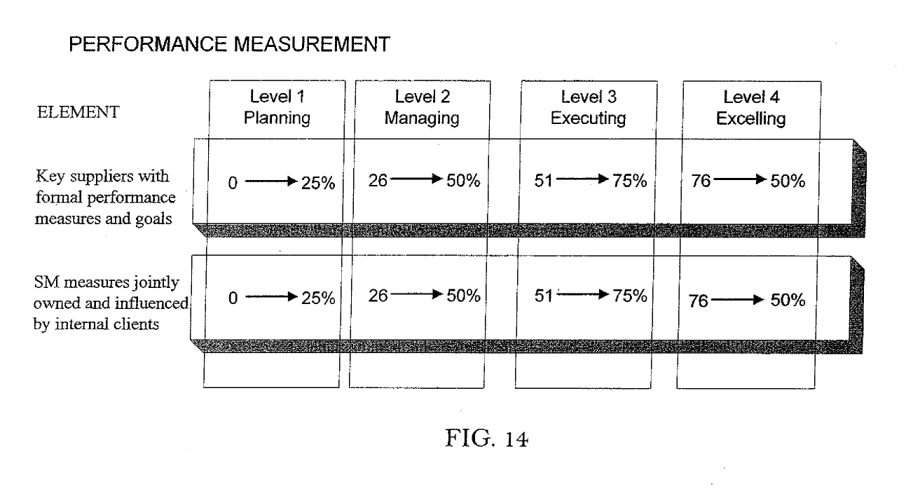

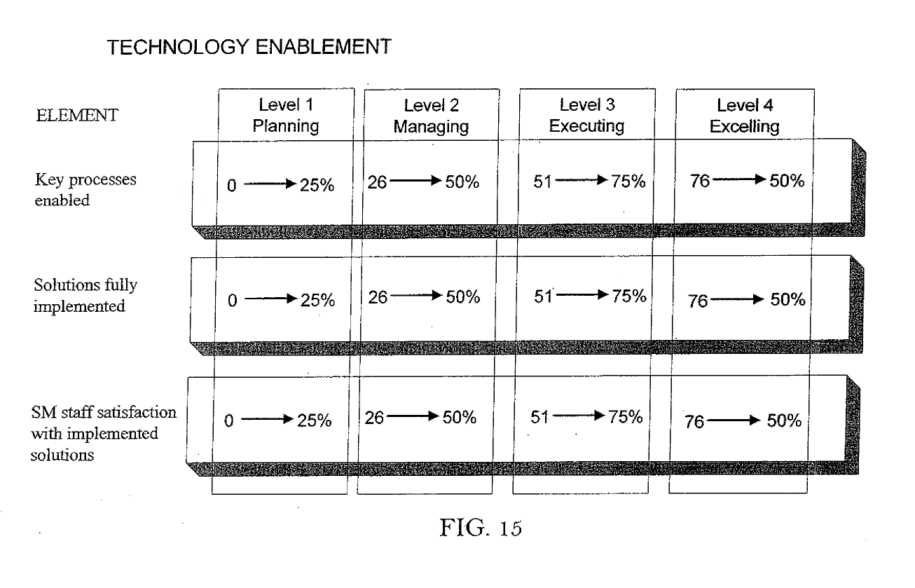

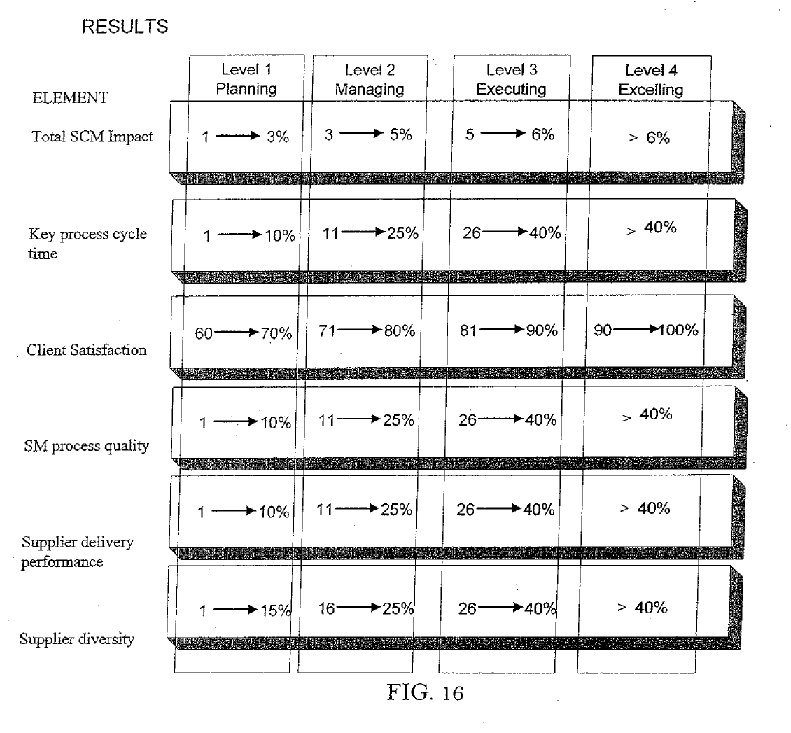

The elements of the other categories are related to maturity levels in a similar manner. For example, FIG. 6 illustrates relationships between the elements of the Supply Chain Integration category and the four maturity levels. FIGS. 7-16 illustrate the relationships between the four maturity levels and the elements of the other categories, specifically, Supply Management Leadership (FIG. 7), Human Capital (FIG. 8), Innovation (FIG. 9), Cross-functional Integration (FIG. 10), Value Management (FIG. 11), Supplier Relationship Management (SRM) (FIG. 12), Client Relationship Management (CRM) (FIG. 13), Performance Management (FIG. 14), Technology Enablement (FIG. 15), and Results (FIG. 16).

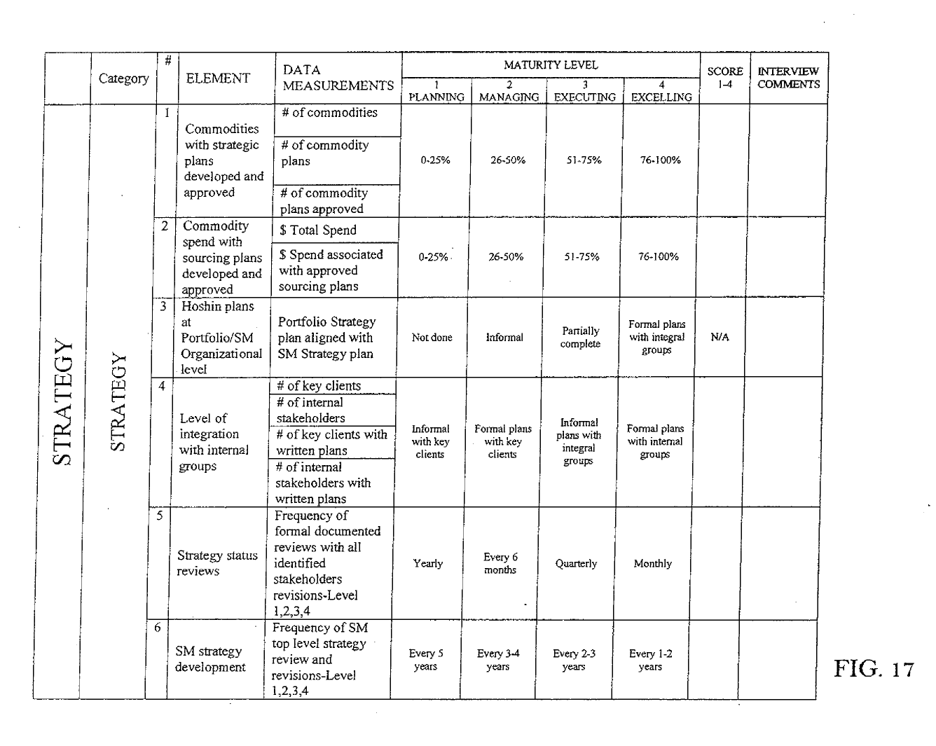

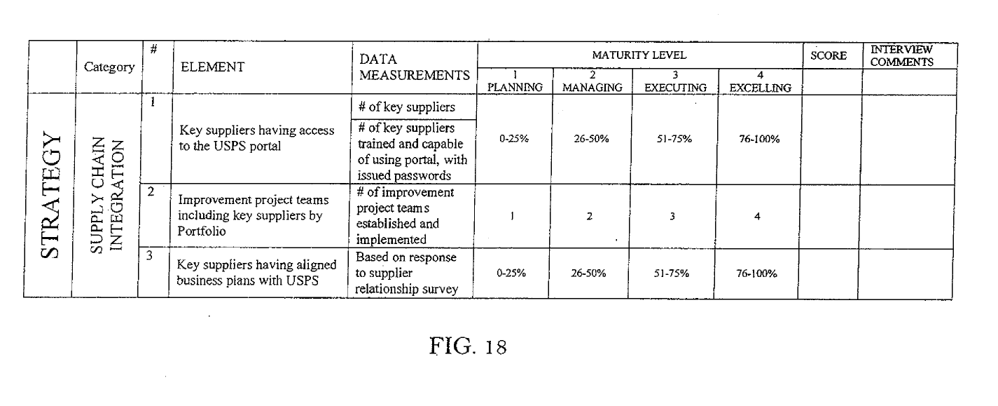

The maturity level of each element in a category can be assessed by using one or more objective and measurable criteria (which are referred to herein as “Data Measurements”) that are associated with the element. FIGS. 17 and 18 illustrate Data Measurements that are used to specifically assess the maturity level of each element in the strategy dimension, that is, for the Strategy category (FIG. 17) and the Supply Chain Integration category (FIG. 18), according to one embodiment. Referring to FIG. 17, the data measurements that are used to assess the maturity level of the element “Commodities with strategic plans developed and approved” include (1) the number of commodities are determined, (2) the number of commodity plans, are then determined, and (3) the number of commodity plans approved is evaluated. The percentage of commodity plans approved determines the maturity level, e.g., level 1 for 0-25%, level 2 for 26-50%, level 3 for 51-75%, and level 4 for 76-100%.

Due to the broad scope of the data used in the Maturity Model, an assessment of the supply chain organization typically includes participation of numerous people in the supply chain organization. To facilitate a consistent maturity assessment, the Maturity Model includes specific implementation information (e.g., background information) that can be used for assessing each element. The implementation information can include, for example, “How-To” instructions, “Definitions” and “Intervention” techniques that can be used in the assessment of the maturity level of each element. The “How-to” instructions includes details of the tasks involved in assessing the maturity of each element and instructions on how to measure the element and transform the measurement into a maturity level. The “Definitions” include terms that may be unfamiliar to supply chain personnel and that can be related to measuring the element. The “Intervention” techniques includes suggestions for improving the maturity level, and also techniques for measuring and assessing the element.

According to some embodiments, the implementation instructions for the element “Commodities with strategic plans developed and approved” in the strategy category includes the following information:

How to Instructions

1. Define commodities for portfolio.

2. Develop plans for all commodities to have strategic plans created by cross-functional teams.

3. Train staff on template. Template may include:

| | |
|---|---|
| (a) | Market analysis |
| (b) | 4-quadrant |
| (c) | SWOT |
| (d) | Commodity segmentation |
| (e) | Porter's 5 Forces |
| (f) | Spend profile |
| (g) | Benchmarking results |
| (h) | Commodity goals |
| (i) | Sourcing plans |
| (j) | Logistics considerations: |
| | Positioning of inventories |
| | Special transportation considerations |
| | Standardization of parts and components |
| | TCO factors |
| | Life-cycle considerations, including disposal |
| (k) | Implementation timetable |

4. Ensure that plans are submitted in timely manner and follow template. Portfolio, SM Leadership Team, and Key Clients must approve plan in writing.
5. Measure element by the percent of Portfolio Commodity Plans that have been approved by supply management leadership team and key clients

### DEFINITIONS

1. Market Analysis: The analysis of a commodity in terms of segmentation, trends in supply and demand, economic factors, make/buy analysis, volatility and risk.

2. 4-Quadrant Approach: A categorization of commodities or sourcing plans based on the strategic importance of the goods and services and market complexity.

3. SWOT: An analysis of strengths, weaknesses, opportunities and threats given the commodity in the market.

4. Commodity Segmentation: The way that commodity markets are broken down into product or services to satisfy client demands in specific industries, applications, and locations.

5. Porter's 5 Forces: A model advocated by Michael Porter that evaluates the profitability and attractiveness of a given market in terms of barriers to entry, power of buyers and suppliers, substitutes and exit barriers, as well as industry competitiveness.

6. Spend Profile: A set of data that describes the amount spent, number of suppliers used, clients served, purchasing locations and commonality of suppliers.

7. Benchmarking: The process of evaluating other organizations' processes, performance, and systems and comparing results to USPS SM.

8. Technology Conditions: The current and future trends in technology, either design or application, that may impact the use of a specific product or service, or to allow substitutes.

Intervention

1. Hold an intensive off-site meeting with commodity team members and stakeholders

2. Develop draft plans for review using the agreed-upon template

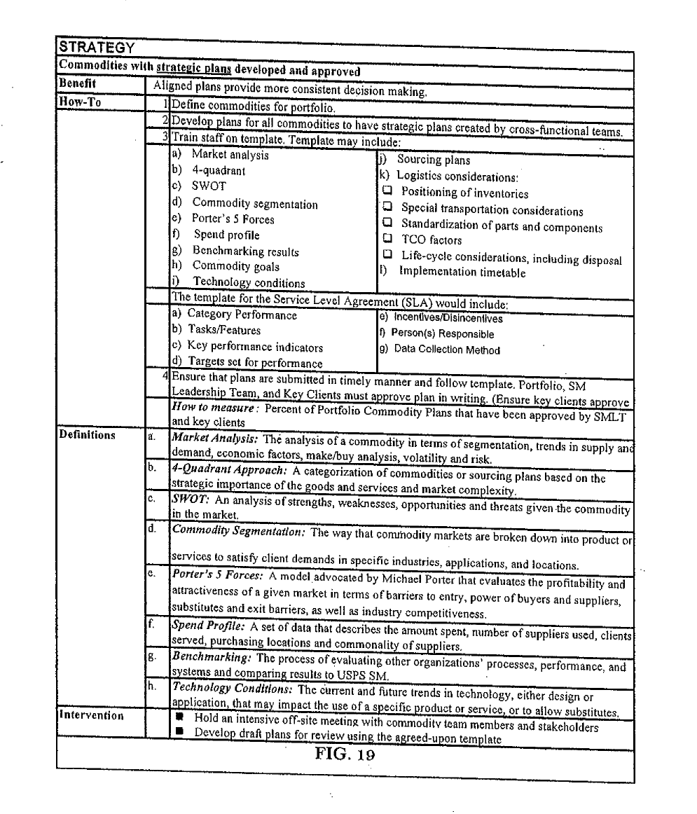

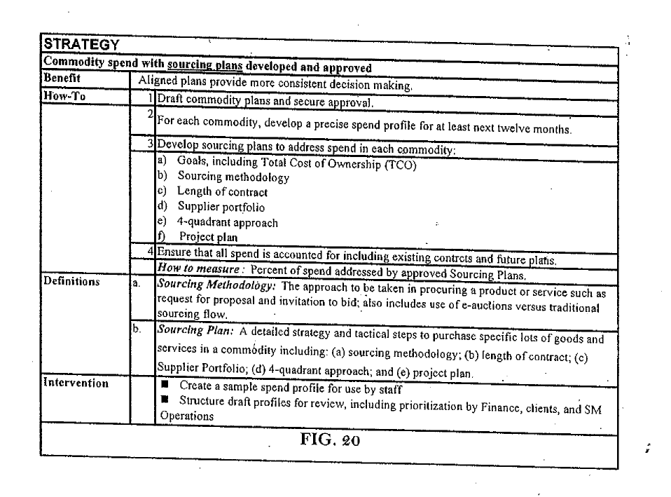

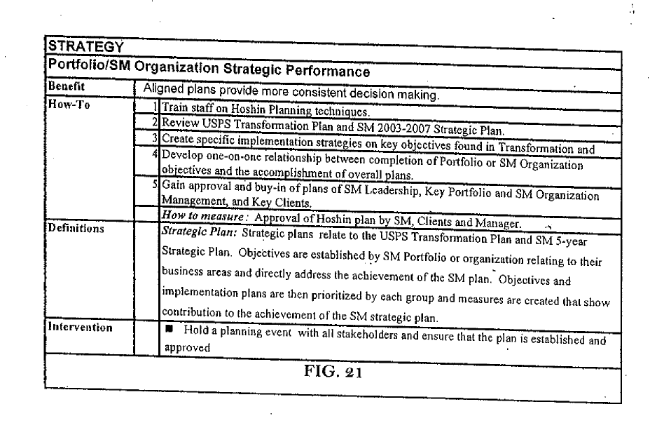

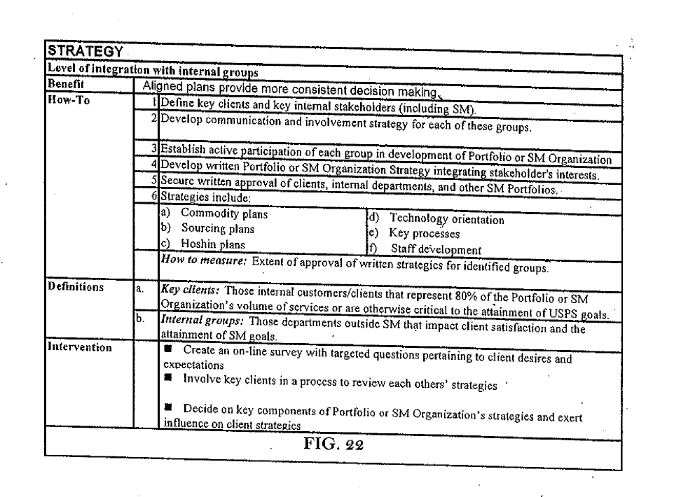

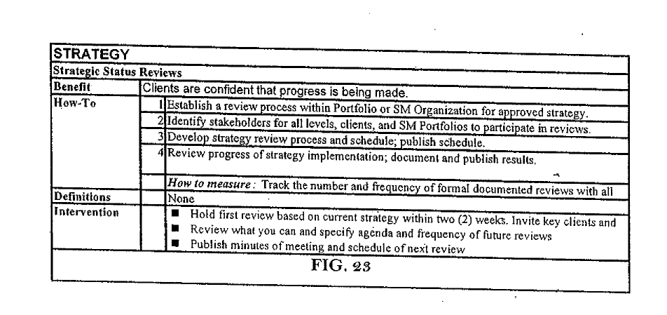

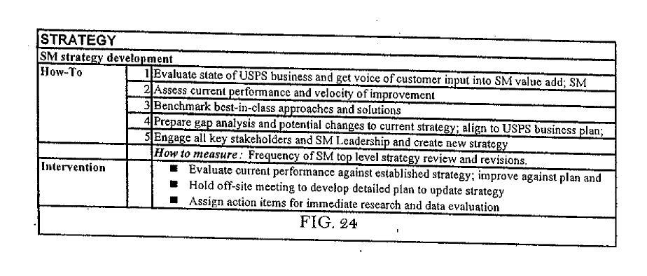

The implementation instructions for the element “Commodities with strategic plans developed and approved” are also shown in FIG. 19. Implementation instructions for each of the other elements in the Strategy category are illustrated in FIG. 20-24.

In another example, FIG. 18 illustrates the elements that are included in the “Supply Chain Integration” category, according to some embodiments. For each element, FIG. 18 also identifies one or more data measurements, and shows the corresponding relationship between the elements and an assessed maturity level.

To assess the maturity level of each element, the Data Measurements are collected for each element. For example, the two Data Measurements that are collected for the element “key suppliers having access to the organization portal” are the number of key suppliers, and the number of key suppliers trained and capable of using the organization portal, with issued passwords. The Data Measurement collected for the element “improvement project teams including key suppliers by portfolio” is the number of improvement project teams established and implemented. The Data Measurement for the element “key suppliers having aligned business plans with the business entity” is the number of key suppliers based on the response to a supplier relationship survey or questionnaire. The Data Measurement for each of these elements is transformed to a maturity level using corresponding implementation instructions in the Maturity Model. For example, the Data Measurement information for the element “key suppliers having access to the organization portal” is transformed to a maturity level using the implementation instructions, shown below:

How to Instructions

1. Define key suppliers.

2. Develop strategy with IT to implement supply organization portal.

3. Communicate portal plans to suppliers; set up access.

4. How to measure: Percentage of key suppliers trained and capable of using portal, with issued passwords. Secondary measure: Percentage of key suppliers using portal on monthly basis.

Intervention

1, Communicate development and status of portal and intended benefit.

2. Hold several supplier conferences describing utility of portal.

3. Establish a contractual requirement for portal sign-up and usage.

4. Create a “burning platform” such as pickup of required data or need for status reporting using the portal.

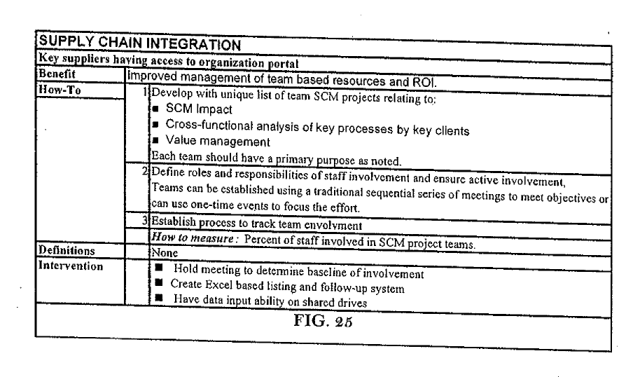

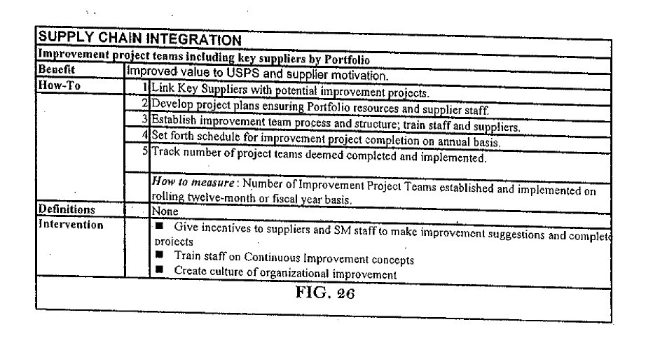

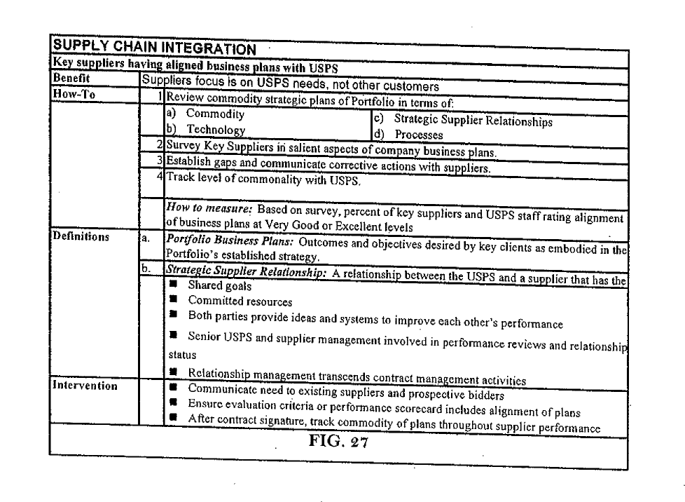

The above-stated implementation information is also illustrated in table form in FIG. 25. Data Measurements for the other two elements in the Supply Chain Integration category, e.g., elements “improvement project teams including key suppliers by portfolio” and “key suppliers having aligned business plans with the business entity,” are transformed to a maturity level using implementation instructions illustrated in FIGS. 26-27, respectively.

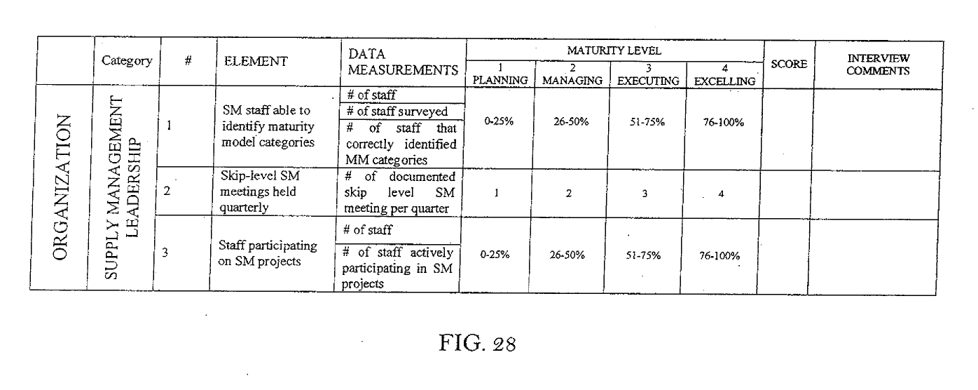

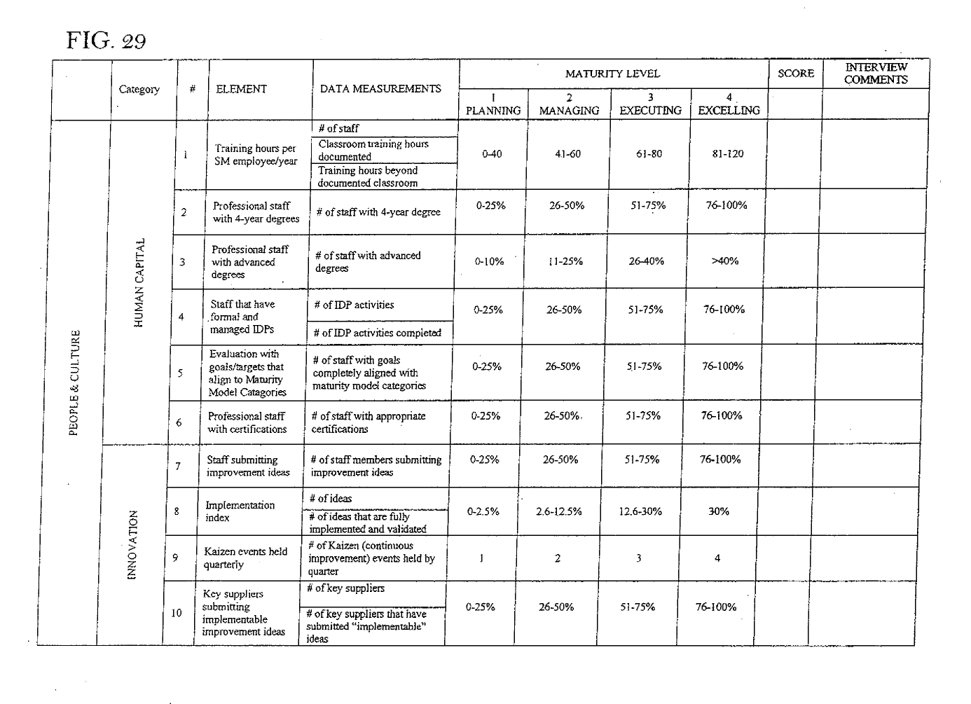

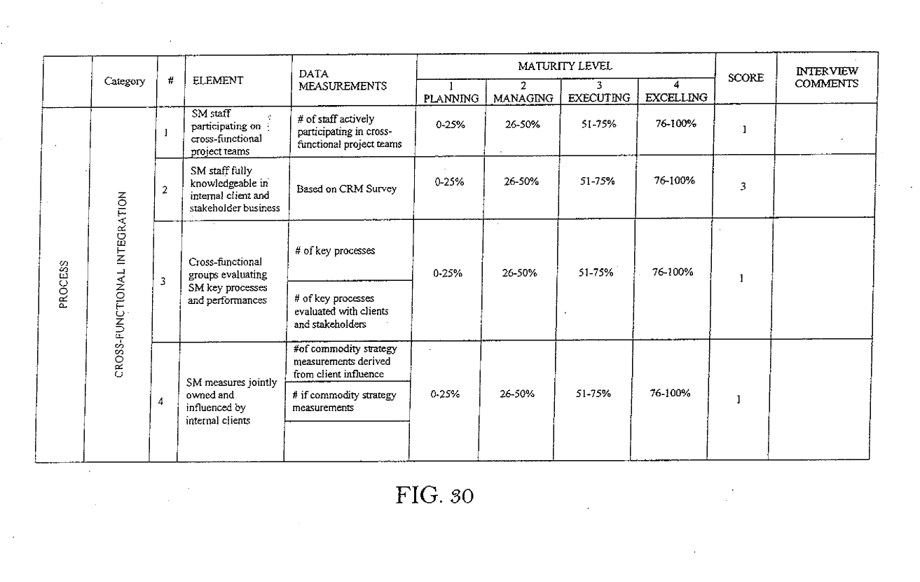

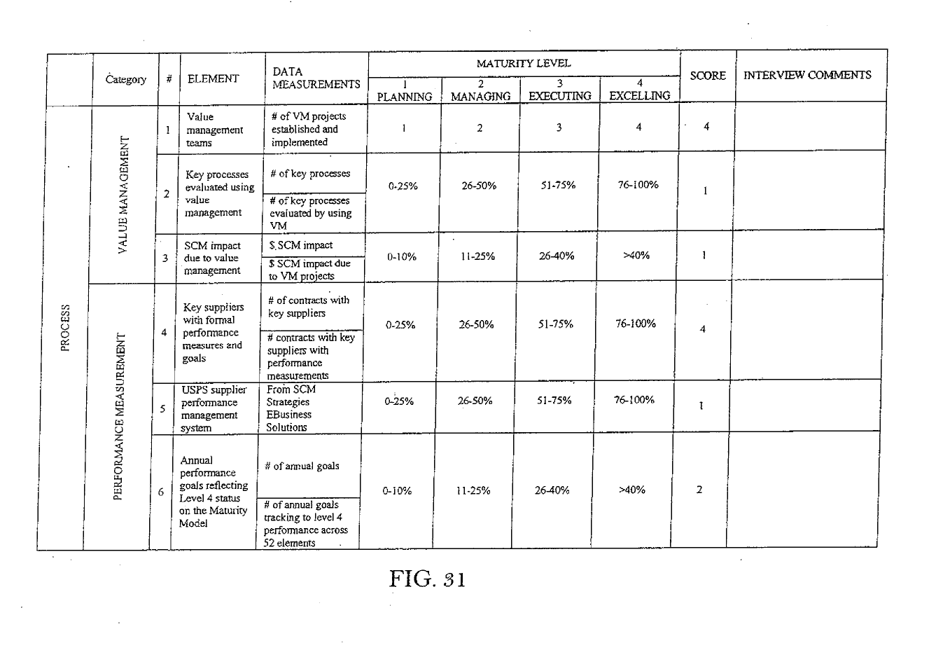

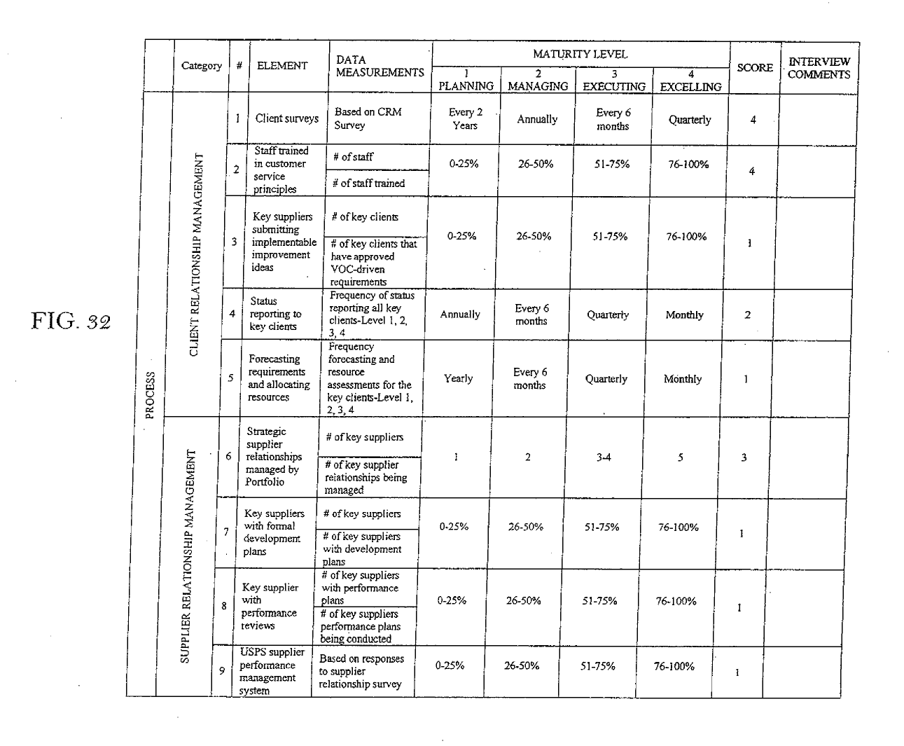

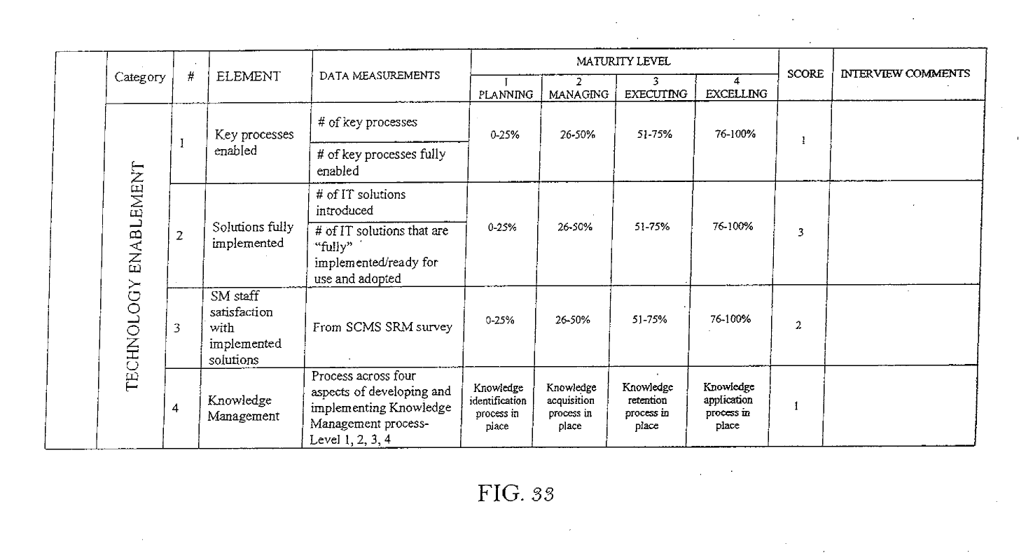

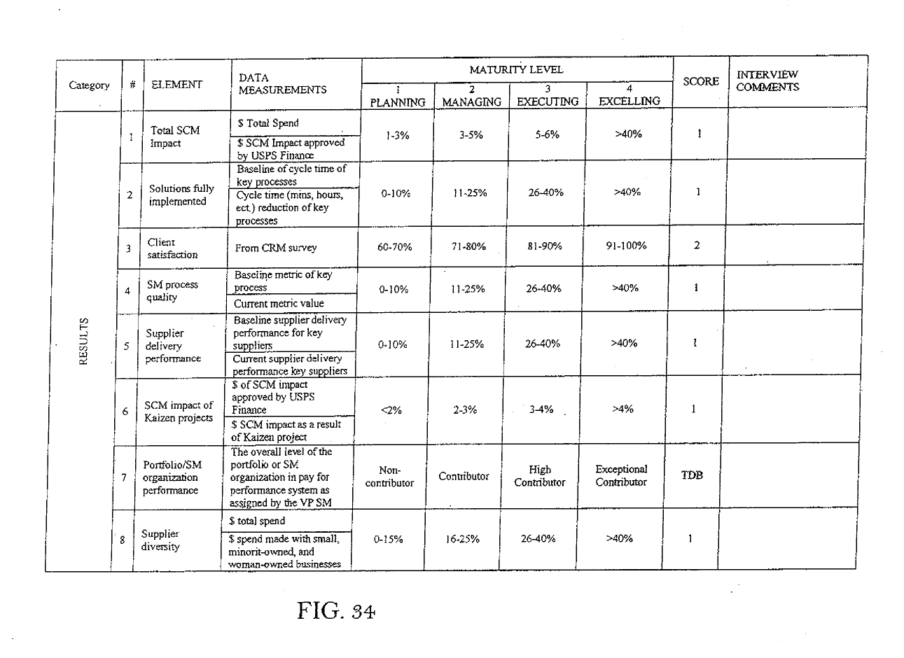

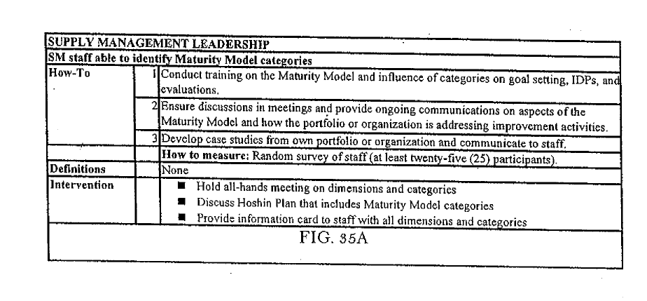

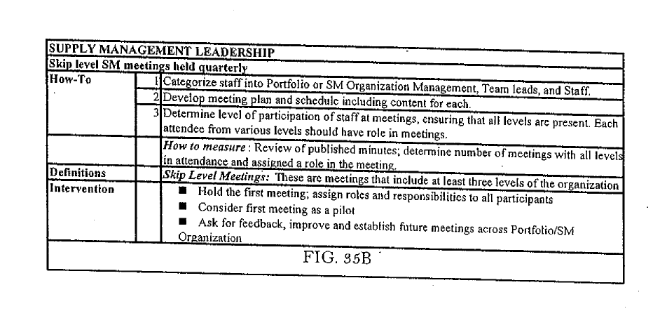

Similar to the above-described data measurements and implementation instructions, each of the elements in the other categories also has associated data measurements and corresponding implementation instructions that are used to assess the element under the Maturity Model. FIGS. 28-34 are tables illustrating examples of data measurements that can be used to assess a maturity level for each element in the categories Supply Management Leadership (FIG. 28), Innovation (FIG. 29), Human Capital (FIG. 29), Cross-Functional Integration (FIG. 30), Value Management (FIG. 31), Performance Measurement (FIG. 31), Client Relationship Management (FIG. 32), Supplier Relationship Management (FIG. 32), Technology Enablement (FIG. 33) and Results (FIG. 34), respectively.

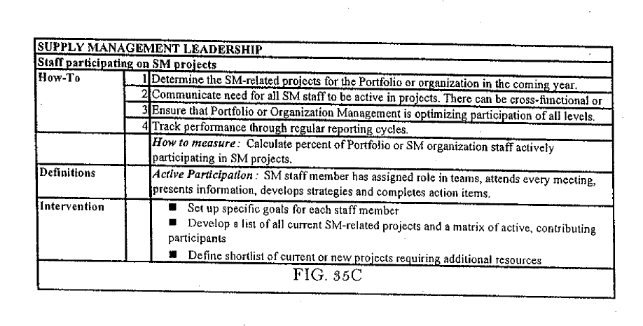

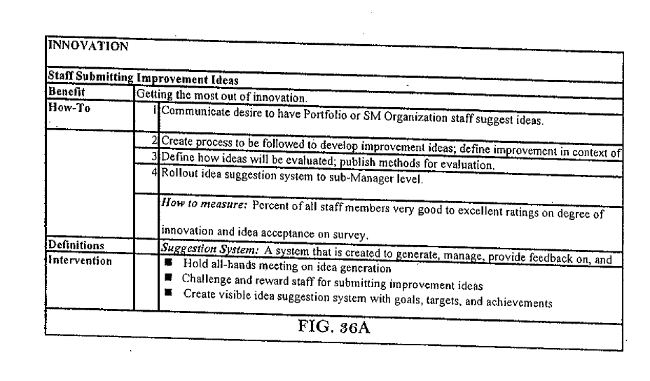

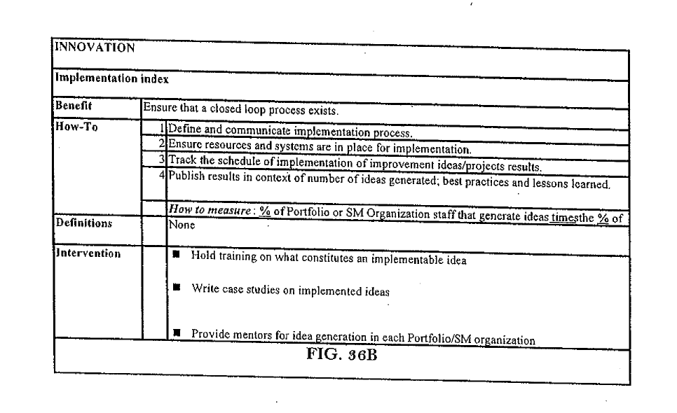

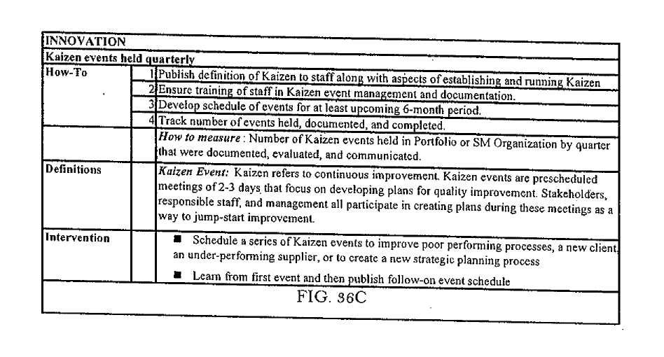

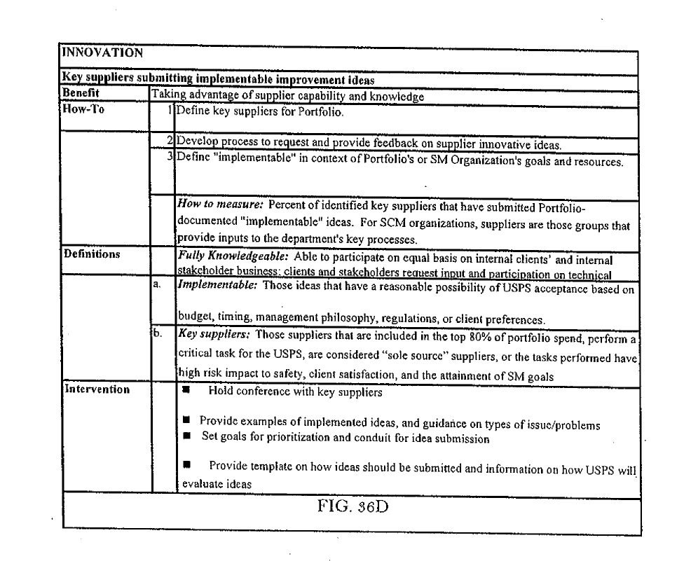

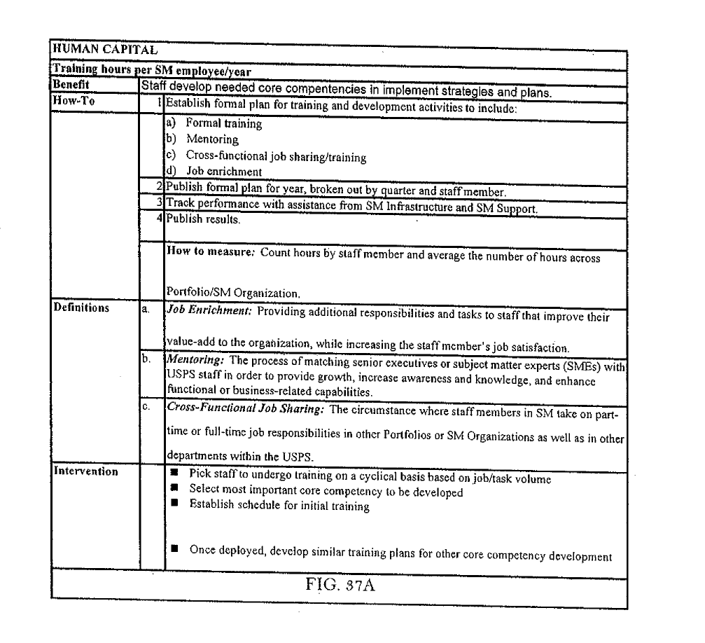

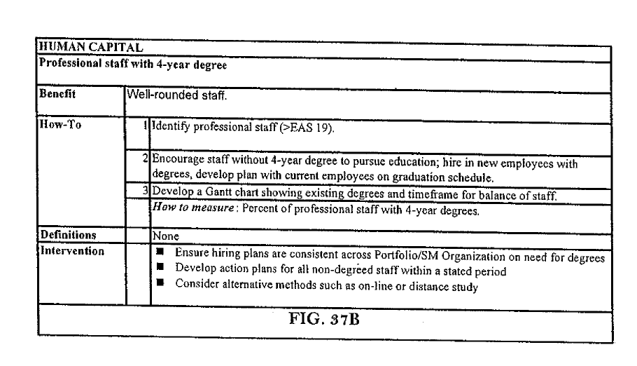

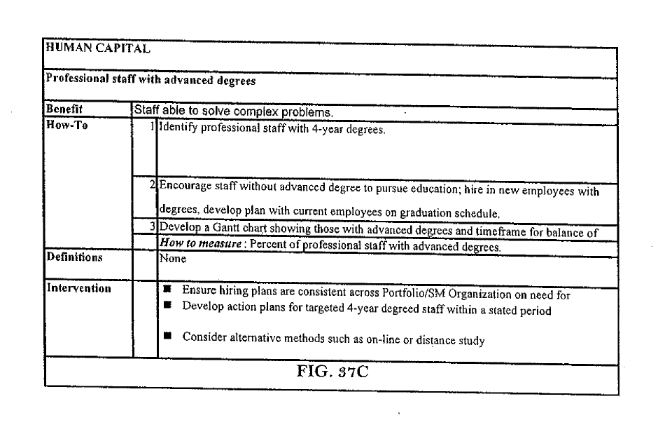

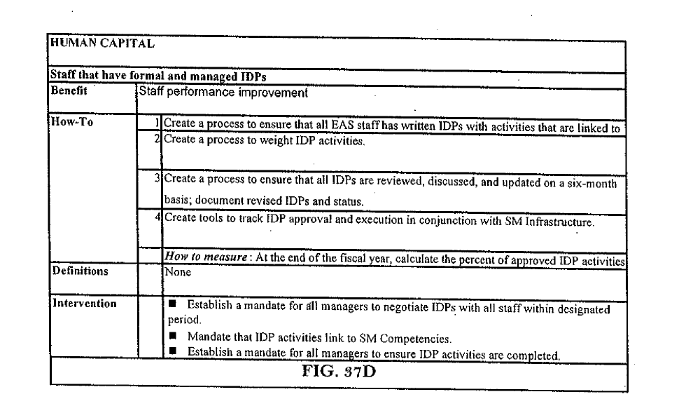

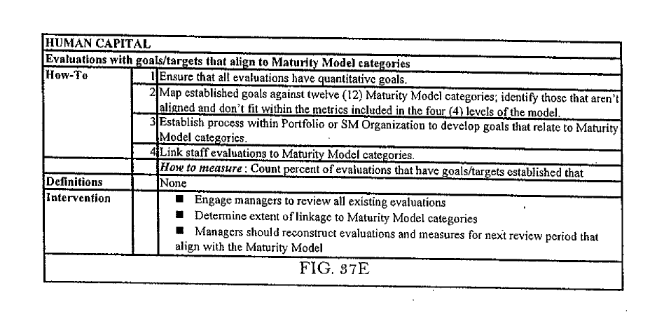

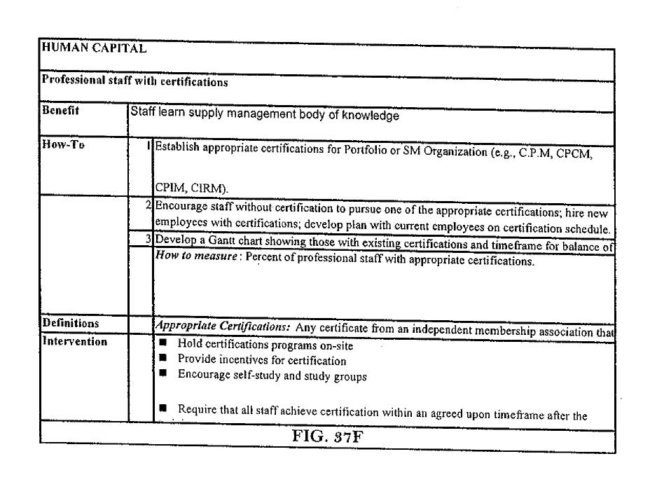

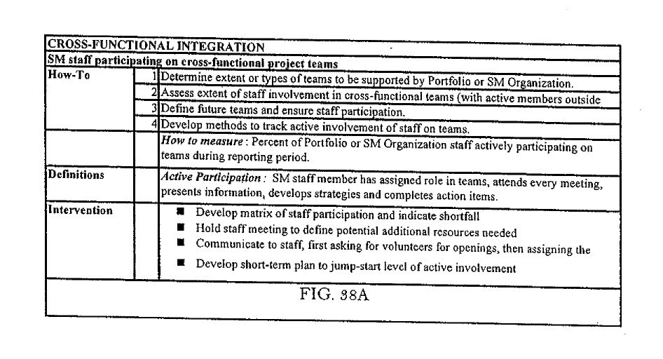

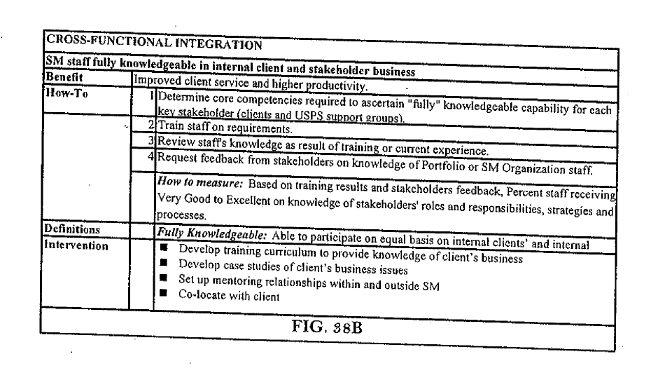

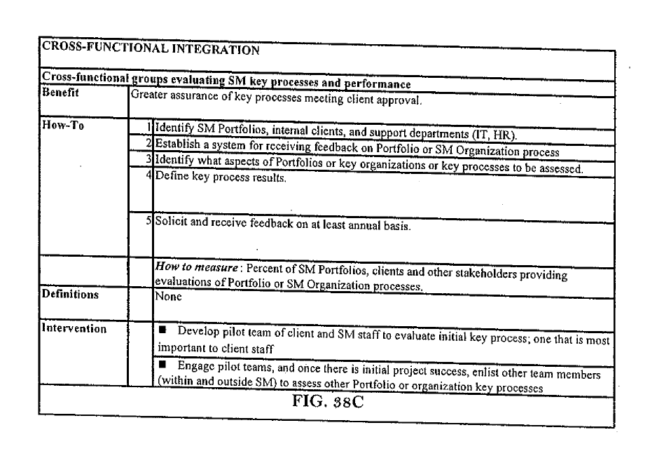

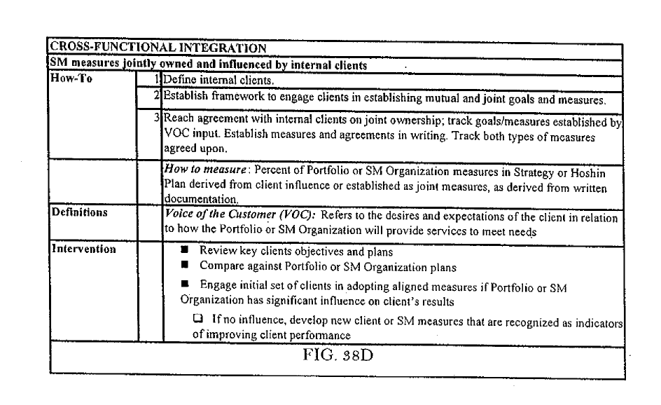

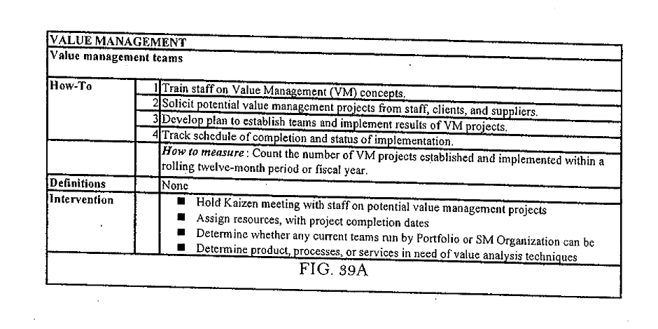

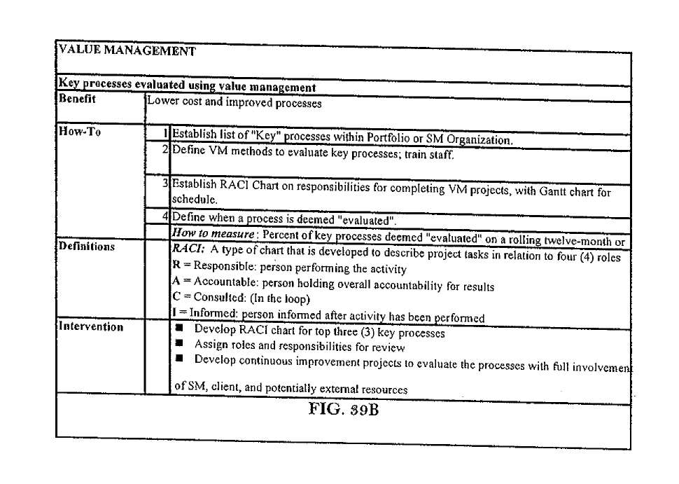

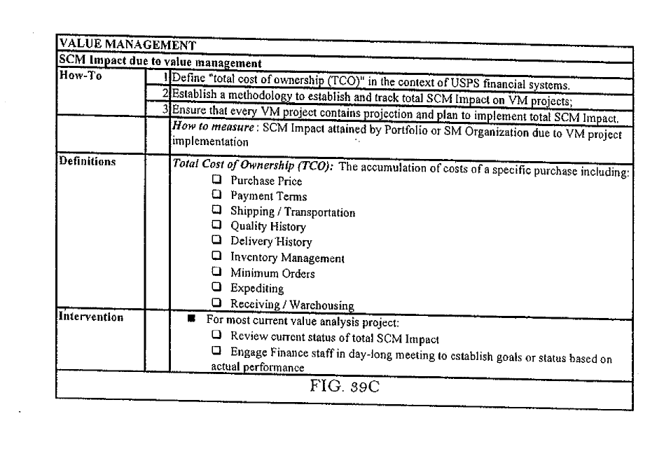

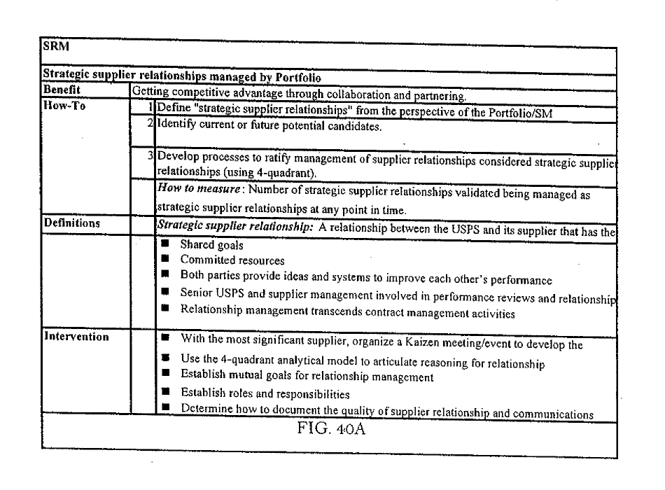

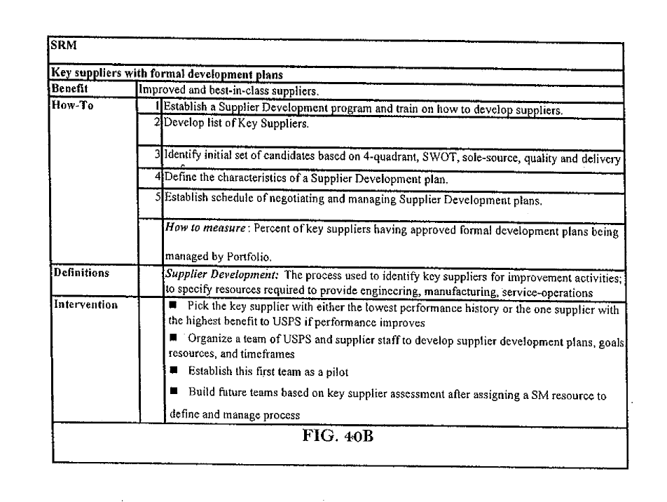

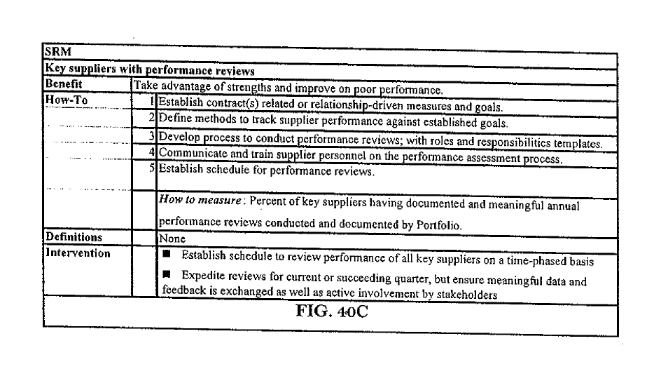

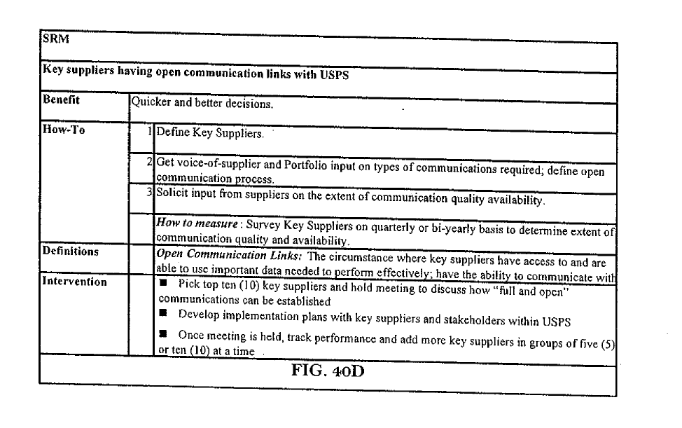

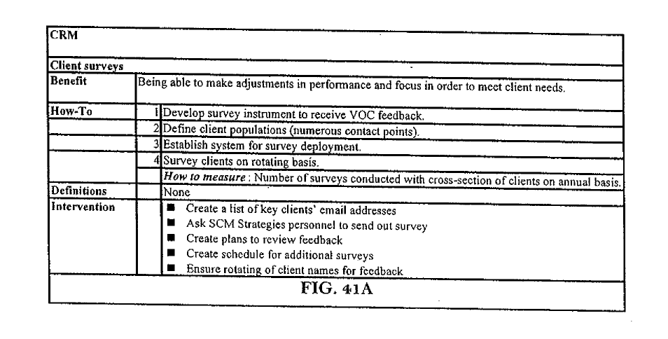

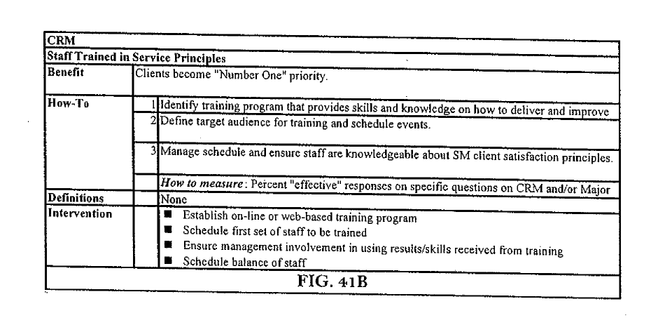

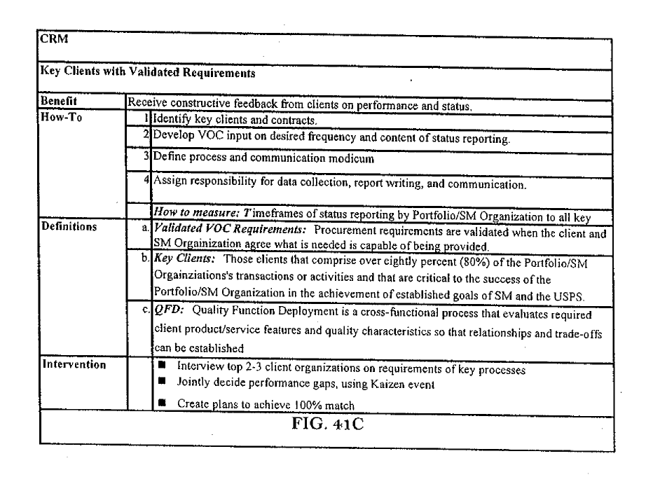

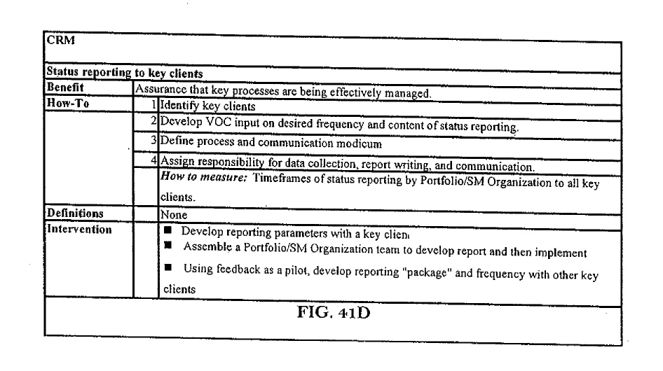

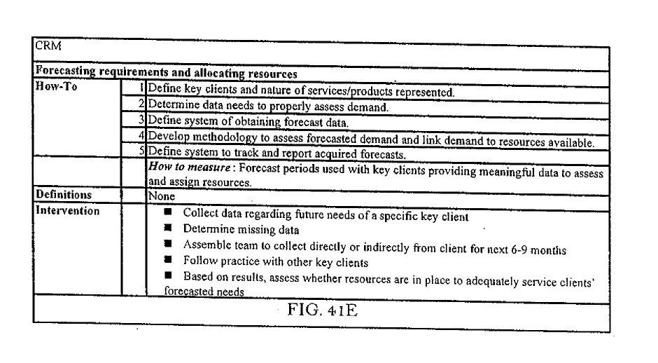

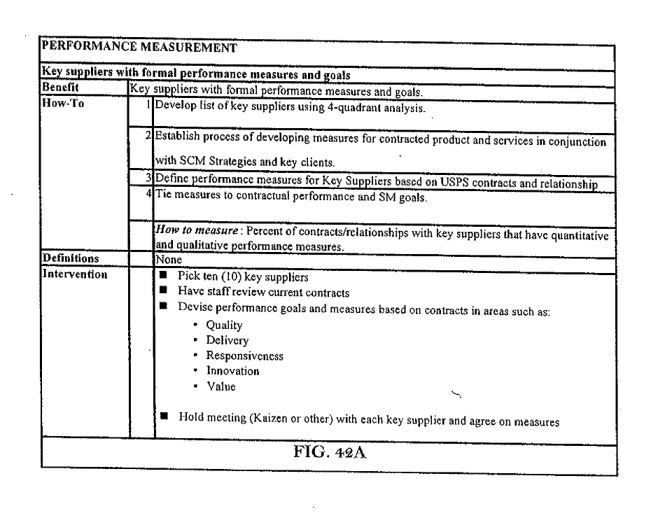

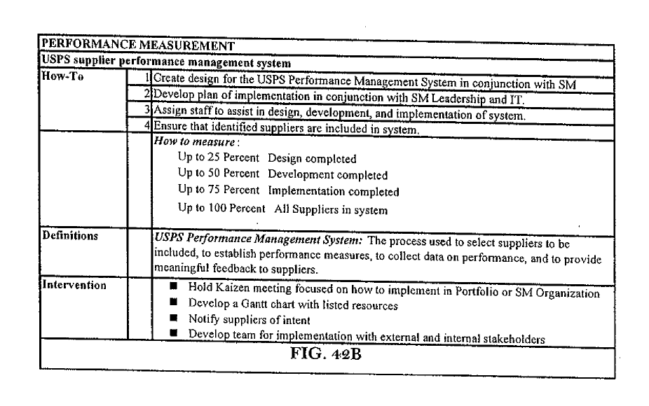

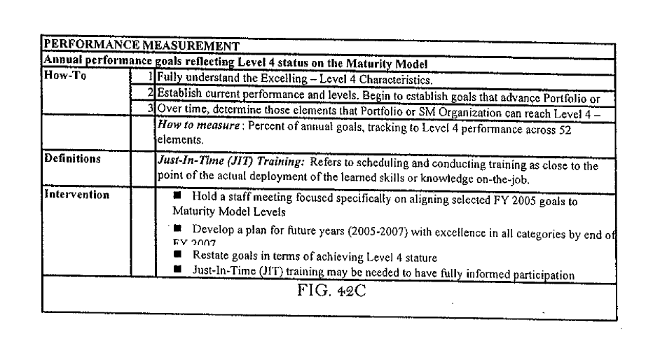

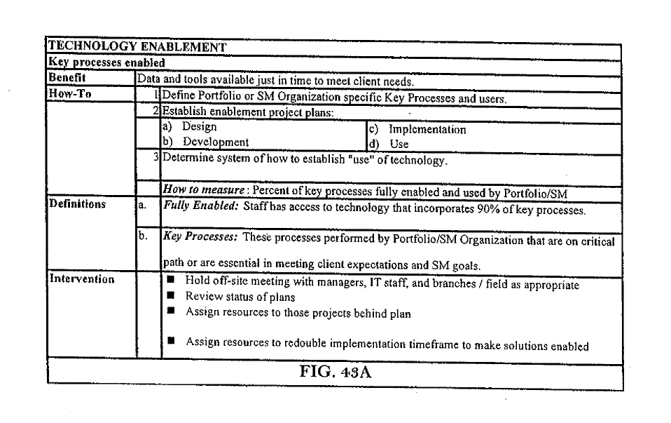

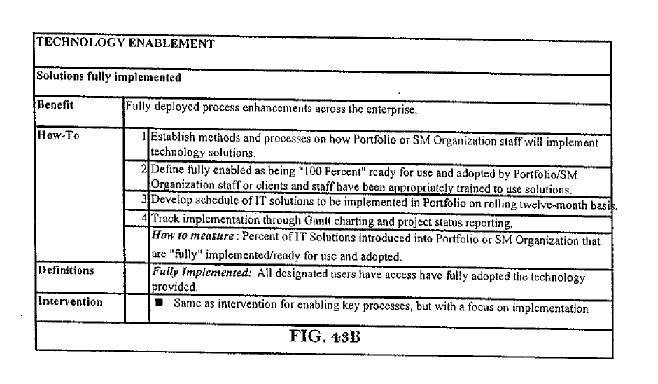

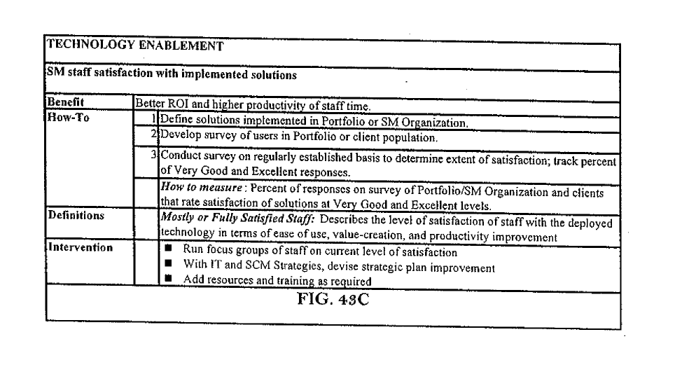

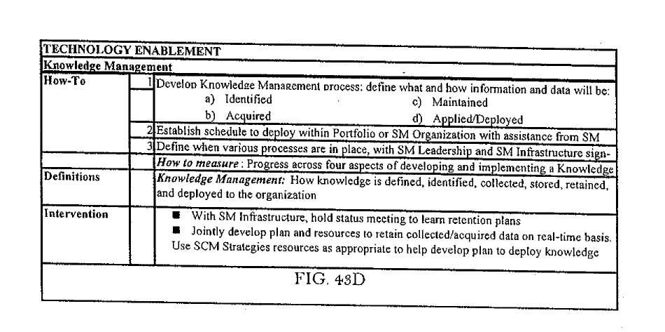

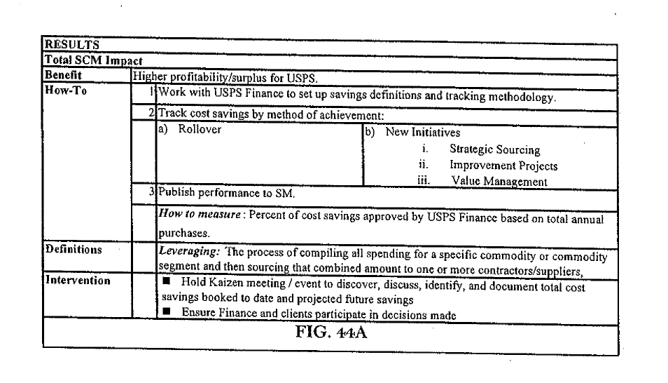

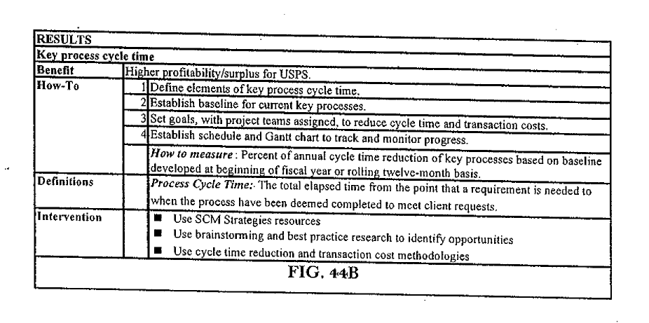

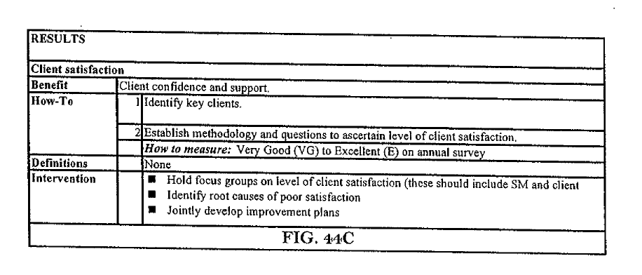

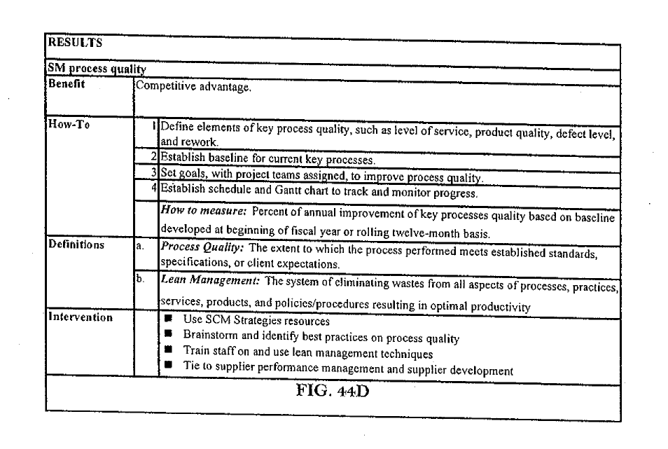

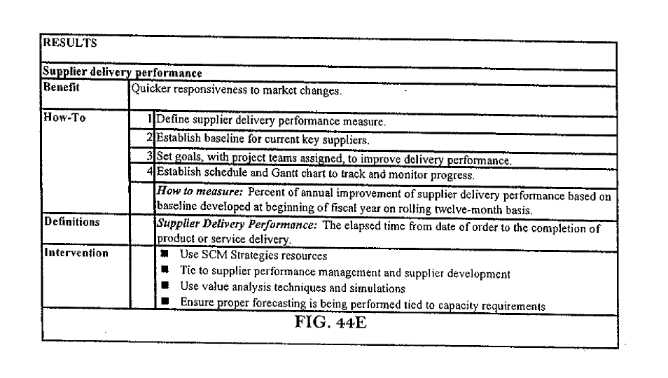

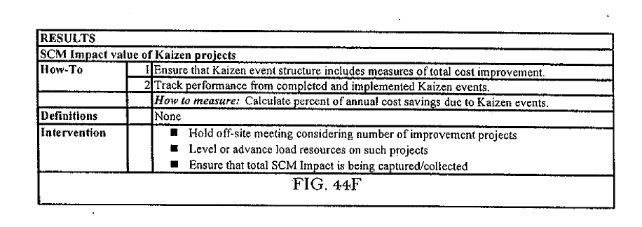

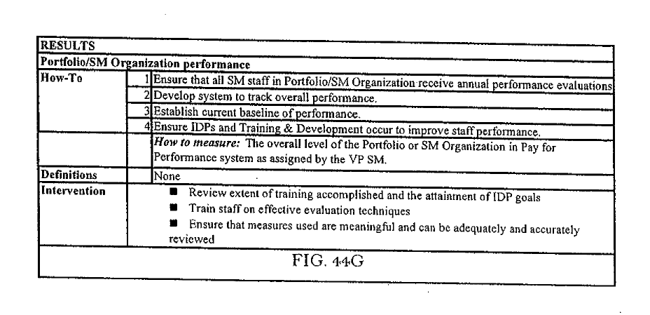

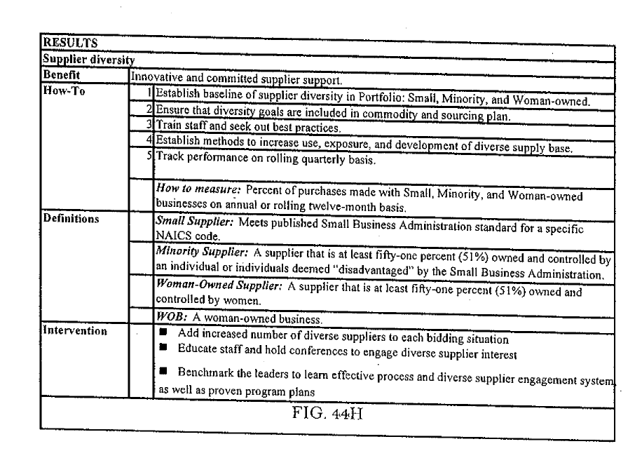

The Maturity Model also provides implementation instructions for each element in the above-listed categories, as illustrated in tables in FIGS. 35-44, specifically, Supply Management Leadership (FIGS. 35A-C), Innovation (FIGS. 36A-D), Human Capital (FIGS. 37A-F), Cross-Functional Integration (FIGS. 38A-D), Value Management (FIGS. 39A-C), Supplier Relationship Management (FIGS. 40A-D), Client Relationship Management (FIGS. 41A-E), Performance Measurement (FIGS. 42A-C), Technology Enablement (FIGS. 43A-D) and Results (FIGS. 44A-H), respectively.

The maturity level of a portfolio can be assessed in roll-up fashion. That is, the appropriate information to support each data measurement for an element can be collected (e.g., identified, created and/or gathered) and the maturity of the element can be determined as specified in the How-to implementation information by transforming the collected data into a maturity level. Once the maturity level of the elements comprising a category are assessed to be a particular maturity level, the maturity level of the category is determined based on the maturity level of each of its elements. In some embodiments, the maturity level of a category is determined by averaging the maturity levels of the elements in the category. Typically, the elements are evenly weighted. However, in some embodiments one or more elements can be weighted to emphasize the importance of a particular element. Also, once the maturity level of the elements is determined, a maturity level of a dimension or a portfolio be determined based on the maturity level of the elements comprising the dimension or the portfolio, either by averaging the maturity levels of the elements with the elements evenly weighted, or by weighting one or more elements to emphasize the importance of a particular element.

In some analyses of the maturity assessment of a portfolio, it can be useful to evaluate the maturity assessment results at the element, category, dimension, or portfolio level, or combinations thereof. For example, analysis of an assessed maturity level of a portfolio may require comparing assessment results of one year to a previous year, and evaluating any change that occurred. For a high-level analysis, the results from year to year can be compared at the dimension level. For a more detailed analysis, the year-to-year results can be compared at the category level. To see the most detail for analysis, the results from year-to-year can be compared at an element level.

To assess the maturity level of one or more elements, supply chain management system assessment information is collected and/or determined from appropriate users of the management system. In some embodiments, the assessment information is collected at regular intervals throughout the year, which allows for comparison of previous assessment results during similar time periods. The supply chain management system assessment information comprises information relating to the one or more Data Measurements that are used to assess each element, as described herein and illustrated in FIGS. 28-34. For each element a response to a request for supply chain management assessment information is received and transformed to a numerical value or another metric, in accordance with the Data Measurement and the How-To instructions. The numerical value or metric indicates a maturity level for the element, as described above.

A graphical representation (e.g., a chart, graph, or table) can be generated that is indicative of a least a portion of the transformed data. In various embodiments, the graphical representation can illustrate the transformed data in different formats, and can include the assessed portfolio, dimensions, categories, elements, the maturity level for one or more of the portfolio, dimensions categories, or elements, and the corresponding transformed numerical values, or any combination thereof. In some embodiments, the graphical representation includes the Data Measurements to provide insight into how the transformation is performed. In some embodiments, the graphical representation includes previous assessment data. In some embodiments, the graphical representation includes a determined difference value between the current numerical value or maturity level of an element, category, dimension and/or portfolio and a previous assessment of an element, category, dimension and/or portfolio. FIGS. 45A-H illustrate examples of graphical representations for the above-described categories and elements without the actual numerical values or maturity levels filled in. In these examples, each category is depicted along the left-hand side of the table. The corresponding elements for each category are shown along the left side of the graphical representation. The one or more portfolios are shown along an upper row as P1, P2, . . . PN. FIGS. 45A-H also illustrate a column for previous assessment data (e.g., “Previous Average”), current assessment data (e.g., “Current Average”), and the difference between the previous assessment data and the current assessment data (e.g., “Change”).

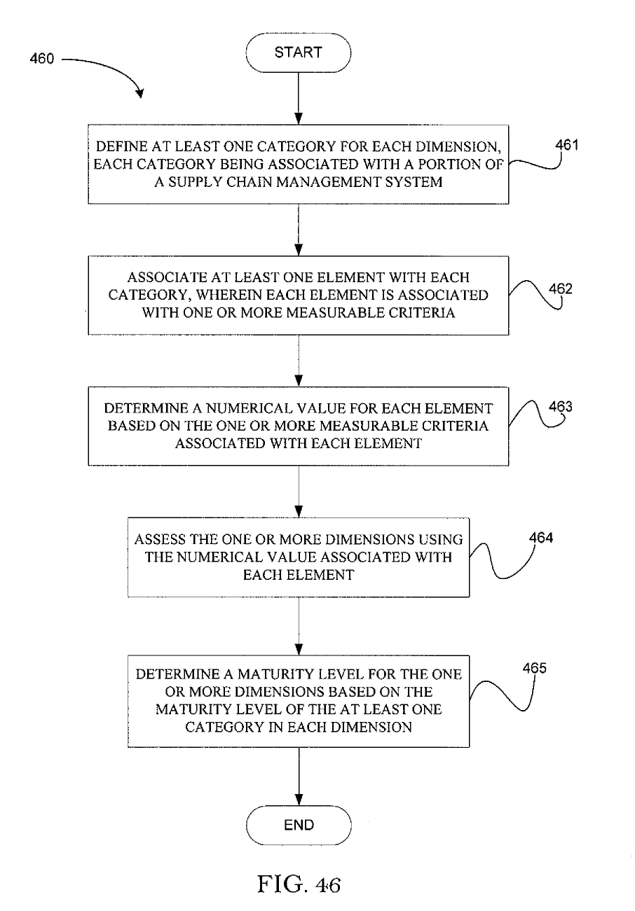

FIG. 46 is a flowchart illustrating one example of a process 46 of assessing one or more dimensions in a supply chain management system. After it starts, at state 461 process 46 defines at least one category for each dimension. Each category is associated with a portion of a supply chain management system. The categories can be one of those described herein (e.g., for the dimension Strategy the categories are Strategy and Supply Chain Integration).

Process 460 then proceeds to state 462 where it associates at least one element with each category, wherein each element is associated with one or more measurable criteria. The elements can be one of those described for the categories herein, or another element. In one example, the process 460 associates the category Strategy with the elements (1) Commodities with strategic plans developed and approved; (2) Commodity spend with sourcing plans developed and approved; (3) Hoshin plans at Portfolio/SM Organizational level; (4) Level of integration with internal groups; (5) Strategy status reviews; and (6) SM strategy development. FIG. 17 illustrates an example of associating an element with measurable criteria for the Strategy element. As shown in FIG. 17, one element “Commodities with strategic plans developed and approved” is associated with data measurements (1) # of commodities; (2) # of commodity plans; and (3) # of commodity plans approved.

Process 460 then proceeds to state 463 where it determines a numerical value for each element based on the one or more measurable criteria associated with each element. Again referring to FIG. 17, a numerical value can be determined for each element based on the data measurements using the defined Maturity Level percentage criteria.

At state 464, process 460 assesses the one or more dimensions using the numerical value associated with each element. The numerical values can be, for example, averaged. Or, the numerical values can have a weight assigned, and then be averaged. At state 465 process 460 determines a maturity level for the one or more dimensions based on the maturity level of the at least one category in each dimension. If the dimension has a single category then the maturity value of the category will typically be the maturity level of the dimension. If the dimension comprises multiple categories, the maturity level of the dimension can be based on the multiple categories (e.g., averaged).

In some embodiments, the assessment information, collected in accordance with the Data Measurements, can be input into a computer based Maturity Model tracking tool. The tracking tool can be structured as a database, a spreadsheet, or another suitable means of organizing information. For example, in some embodiments the tracking tool is implemented in a Microsoft Excel spreadsheet. The tracking tool can be structured to include applicable dimensions, categories, and elements of one or more portfolios. The tracking tool can be configured to perform transformation of the assessment information of an element to a numerical value and associate a maturity level with the numerical value. The tracking tool can also be configured to produce graphical representations that include one or more of portfolios, dimensions, categories, elements, data measurements, assessed numerical values for an element, assessed non-numerical metrics for an element, maturity levels, a summarized maturity level for an element, category, dimension, or a portfolio, previous assessment data, differences between the current assessment data and previous assessment data, and comments associated with any displayed information.

It is also noted that examples may be described as a process, which is depicted as a flowchart, a flow diagram, a structure diagram, or a block diagram. Although a flowchart may describe the operations as a sequential process, many of the operations can be performed in parallel or concurrently and the process can be repeated. In addition, the order of the operations may be re-arranged, operations not shown may be performed, or operations shown may be omitted depending on circumstances of an application of the process.

While the methods and system as described herein may be utilized, in one embodiment, for the maturity assessment of the United States Postal Service's supply chain management system, the methods and systems are applicable to any business with a supply chain management system.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

1. A method of assessing one or more dimensions in a supply chain management system, the method comprising:
defining at least one category for each dimension, each category being associated with a portion of a supply chain management system;
associating at least one element with each category, wherein each element is associated with one or more measurable criteria;
determining a numerical value for each element based on the one or more measurable criteria associated with each element;
assessing the one or more dimensions using the numerical value associated with each element; and
determining a maturity level for the one or more dimensions based on the maturity level of the at least one category in each dimension.

2. The method of claim 1, further comprising determining a maturity level for each category based on the numerical value of each associated element.

3. The method of claim 2, wherein determining a maturity level for each category comprises associating each category with one of four maturity levels based on the numerical value.

4. The method of claim 1, wherein determining the numerical value comprises performing one or more steps identified in how-to information that is associated with each element.

5. The method of claim 4, wherein the how-to information comprises one or more definitions, information for determining the measurable criteria associated with the element, and intervention tasks.

6. The method of claim 5, wherein the maturity levels comprise planning, managing, executing, and excelling.

7. The method of claim 1, wherein the plurality of categories comprise one or more of the following categories: strategy, supply chain integration, supply management leadership, human capital, cross-functional integration, innovation, client relationship management, supplier relationship management, performance measurement, value management, technology enablement, and results.

8. A computer-implemented method for processing data associated with a supply chain management system assessment of at least one portfolio, the method comprising:
receiving data in response to a request for supply chain management system assessment information from a plurality of users associated with the supply chain management system, the response data characterizing supply chain process elements in a plurality of categories for the at least one portfolio;
transforming the response data in accordance with a predetermined transformation to a corresponding numerical value; and
generating a display of at least a portion of the transformed response data, the display comprising the numerical values for at least one element in at least category for the at least one portfolio.

9. The method of claim 8, further comprising receiving previous assessment results, and wherein the graphical display further comprises the previous numerical values for each element.

10. The method of claim 9, further comprising calculating the difference between the numerical value for each element and the previous numerical value for each element, and wherein the display further comprises displaying the difference for each element.

11. The method of claim 8, wherein the request for supply chain management process assessment information includes a questionnaire including at least one information request in at least a subset of the following information categories: strategy, supply chain integration, supply management leadership, human capital, cross-functional integration, innovation, client relationship management, supplier relationship management, performance measurement, value management, and technology enablement.

12. The method of claim 8, wherein the predetermined transformation comprises using measurable criteria and the response data to determine the numerical value for each element.

13. An apparatus for processing data associated with a supply chain management system assessment of an entity, the apparatus comprising:
a processor-based system having a processor coupled to a memory and being operative to (i) receive data in response to a request for supply chain management system assessment information from a plurality of users associated with the supply chain management system, the response data characterizing supply chain process elements in a plurality of categories for the at least one portfolio; (ii) transform the response data in accordance with a predetermined transformation to a corresponding numerical value for each element; and (iii) generate a display of at least a portion of the transformed response data, the display comprising the numerical values for at least one element.

14. The apparatus of claim 13, wherein the entity comprises at least one of a company, an organization, and a project.

15. The apparatus of claim 14, wherein the processor is further operative to receive previous assessment results, and wherein the graphical display further comprises the previous numerical values for each element.

16. The apparatus of claim 15, wherein the processor is further operative to calculate the difference between the numerical value for each element and the previous numerical value for each element, and wherein the display further comprises displaying the difference for each element.

17. The apparatus of claim 13, wherein the request for supply chain management process assessment information includes a questionnaire including at least one information request in at least a subset of the following information categories: strategy, supply chain integration, supply management leadership, human capital, cross-functional integration, innovation, client relationship management, supplier relationship management, performance measurement, value management, and technology enablement.

18. A machine readable medium comprising instructions for processing data associated with a supply chain management system assessment, that upon execution cause a machine to:
receive data in response to a request for supply chain management system assessment information from a plurality of users associated with the supply chain management system, the response data characterizing supply chain process elements in a plurality of categories for the at least one portfolio;
transform the response data in accordance with a predetermined transformation to a corresponding numerical value for each element; and
generate a graphical display of at least a portion of the transformed response data, the graphical display comprising the numerical values for at least one element in at least category for the at least one portfolio.

19. An apparatus for processing data associated with a supply chain management system assessment of an entity, the apparatus comprising:
means for receiving data in response to a request for supply chain management system assessment information from a plurality of users associated with the supply chain management system, the response data characterizing supply chain process elements in a plurality of categories for the at least one portfolio;
means for transforming the response data in accordance with a predetermined transformation to a corresponding numerical value for each element; and
means for generating a graphical display of at least a portion of the transformed response data, the graphical display comprising the numerical values for at least one element in at least category for the at least one portfolio.
